(19) United States
(12) Patent Application Publication
(10) Pub. No.: US 2026/0146125 A1
(43) Pub. Date: May 28, 2026

(54) LADDER POLYMERS AND IMPROVED METHODS OF MAKING THE SAME

(71) Applicant: Osmoses Inc., Cambridge, MA (US)

(72) Inventors: Nicholas C. Bruno, Cambridge, MA (US); Samuel E. Cox, Boston, MA (US); Holden Wan Hong Lai, Boston, MA (US); Marina Petsi, Cambridge, MA (US)

(21) Appl. No.: 19/120,606

(22) PCT Filed: Oct. 11, 2023
(86) PCT No.: PCT/US23/34879

§ 371 Date: Apr. 11, 2025

Related U.S. Application Data
(60) Provisional application No. 63/415,524, filed on Oct. 12, 2022.

(51) Int. Cl. C08G 61/02; C08G 61/12

(52) U.S. Cl. CPC C08G 61/02; C08G 61/124; C08G 2261/124; C08G 2261/3325; C08G 2261/3342; C08G 2261/41

(57) ABSTRACT

The present disclosure relates to Norbornyl benzocyclobutene ladder polymers and methods of preparing the same. This disclosure further relates to methods of separating fluids, e.g., gases using norbornyl benzocyclobutene ladder polymers of the disclosure

### CROSS REFERENCE TO RELATED APPLICATIONS

This application claims the benefit of priority to U.S. Provisional Application No. 63/415,524, filed on Oct. 12, 2022, the contents of which are hereby incorporated by reference in their entirety.

### GOVERNMENT SUPPORT

This invention was made with government support under Award Number DE-AR0001659, awarded by the Advanced Research Projects Agency—Energy (ARPA-E), U.S. Department of Energy. The government has certain rights in the invention.

### BACKGROUND

Norbornyl benzocyclobutene ladder polymers are highly glassy (glass transition temperature>decomposition temperature) materials with exceptional thermal stability, with temperature of decomposition >350° C. The highly rigid and contorted backbone of norbornyl benzocyclobutene ladder polymers prevents the efficient packing of polymer chains in the solid state, forming angstrom-sized pores in the polymer matrix. By forming the norbornyl benzocyclobutene ladder polymers into membranes, the resulting pores can be leveraged for size-selective molecular separations. However, using existing methods, the synthesis of ladder copolymers would require the synthesis of dinorbornene monomers from each of the corresponding aryl dibromides or bis(aryl bromide) (except for aryl dibromides or bis (aryl bromide) with ortho substituents, which can be directly polymerized), making the overall process greater than two steps and further adding to the overall cost of the polymer. Accordingly, there exists a need for one-step polymerization methods for synthesizing norbornyl benzocyclobutene ladder polymers, which do not require an ortho-substituted aryl-halide or aryl-pseudo halide.

### SUMMARY

In certain aspects, provided herein are polymers comprising at least one unit of Formula I, wherein Formula I consists of a subunit of Formula I′ and a subunit of Formula I″:

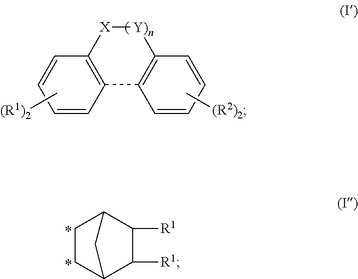

wherein:
each R¹ represents a connection point to the polymer;
each of the two R¹ groups on the subunit of Formula I′ is on an adjacent carbon to another R¹ group;
each R² represents a connection point between the subunit of Formula I′ and a carbon marked with an * on the subunit of Formula I″;
each of the two R² groups is on an adjacent carbon to another R² group;
X is, independently at each occurrence, selected from NR^{A}, O, S, CR^{B}R^{C}, S═O, and C═O;
when present, Y is, independently at each occurrence, selected from NR^{A}, O, S, CR^{B}R^{C}, and C═O;
wherein, when Y is present, at least one of X and Y is CR^{B}R^{C} or C═O;
R^{A} is, independently at each occurrence, selected from H, alkyl, —O-alkyl, or haloalkyl;
R^{B} and R^{C} are, independently at each occurrence, selected from H, OH, SH, halo, amine, alkyl, —(H)C═O, —O-alkyl, and haloalkyl;
or R^{B} and R^{C}, together with the atom to which they are attached, form a cycloalkyl, cycloalkenyl, heterocycloalkenyl, or heterocycloalkyl, which is optionally substituted with one or more R^{G}, wherein R^{G} is selected from H, alkyl, alkyoxyl, and hydroxyl;
n is O or 1; and
--- represents an optional bond.

In further aspects, provided herein are methods of separating fluids comprising passing a mixture of fluids through a separation membrane comprising a polymer of the disclosure.

In yet further aspects, provided herein are methods of making polymers of the disclosure.

In still further aspects, provided herein are methods of making a polymer, the polymer comprising at least one unit of Formula X:

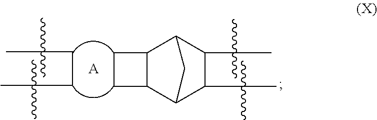

wherein A is a moiety comprising at least two aromatic rings;
wherein the method comprises reacting a compound of formula Xa:

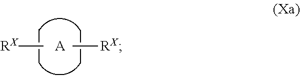

wherein R^{X} is a halide or pseudohalide, such as a triflate, nonaflate, tosylate, or methanesulfonate;
with norbornadiene, in the presence of a palladium catalyst, a ligand, and a base.

### DETAILED DESCRIPTION

Norbornyl benzocyclobutene ladder polymers are highly glassy (glass transition temperature>decomposition temperature) materials with exceptional thermal stability, with temperature of decomposition >350° C. The highly rigid and contorted backbone of norbornyl benzocyclobutene ladder polymers prevents the efficient packing of polymer chains in the solid state, forming angstrom-sized pores in the polymer matrix. By forming the norbornyl benzocyclobutene ladder polymers into membranes, the resulting pores can be leveraged for size-selective molecular separations. Recent work demonstrated that exceptional size selectivity can be achieved for small permanent gases by introducing 3D contortions into the backbone of norbornyl benzocyclobutene ladder polymers.

The fabrication of polymeric materials into mechanically robust membranes, whether they are integral asymmetric membranes or thin film composite membranes in the flat sheet or hollow fiber form, requires high-molecular-weight (weight−average molecular weight>100,000 Da) polymer materials. The first synthetic method developed for norbornyl benzocyclobutene ladder polymers involves the palladium-catalyzed polymerization of ortho-substituted aryl dibromides with 2,5-norbornadiene. Alkyl or aryl substituents ortho to the bromines are necessary to direct efficient and selective formation of the cyclobutene ring. This method cannot achieve molecular weight high enough to make mechanically robust membranes (Lai et al. Macromolecules 2019, 52, 6294-6302). The two-step method for synthesizing high-molecular norbornyl benzocyclobutene ladder polymers recently developed requires the synthesis of dinorbornene monomers, followed by polymerization of the dinorbornene monomer with 1,4-dibromo-2,5-dialkylbenzene, where the alkyl groups can be methyl or ethyl. However, the existing methods have several important drawbacks:
1. Existing methods require two steps, both of which are palladium catalyzed, thus more than doubling the cost of a hypothetical one-step polymerization.
2. While the dinorbornene monomer can be synthesized from aryl dibromides or bis(aryl bromide) with no substituents ortho to the bromines, the polymerization step still requires the ortho substituents. This greatly limits the structural diversity of the norbornyl benzocyclobutene. Improvements in the separation performance of norbornyl benzocyclobutene membranes could be achieved by incorporating monomers with unique structures.

Using existing methods, the synthesis of copolymers would require the synthesis of dinorbornene monomers from each of the corresponding aryl dibromides or bis(aryl bromide) (except for aryl dibromides or bis (aryl bromide) with ortho substituents, which can be directly polymerized), making the overall process greater than two steps and further adding to the overall cost of the polymer.

In view of the foregoing, there exists a need for one-step polymerization methods for synthesizing norbornyl benzocyclobutene ladder polymers, which do not require an ortho-substituted aryl-halide or aryl-pseudo halide.

### Ladder Polymers

In certain aspects, provided herein are polymers comprising at least one unit of Formula I, wherein Formula I consists of a subunit of Formula I′ and a subunit of Formula I″:

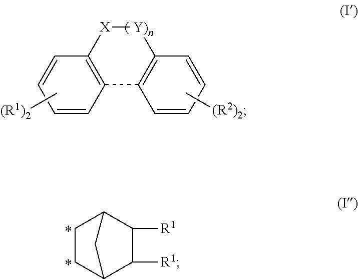

wherein:
each R¹ represents a connection point to the polymer;
each of the two R¹ groups on the subunit of Formula I′ is on an adjacent carbon to another R¹ group;
each R² represents a connection point between the subunit of Formula I′ and a carbon marked with an * on the subunit of Formula I″;
each of the two R² groups is on an adjacent carbon to another R² group;
X is, independently at each occurrence, selected from NR^{A}, O, S, CR^{B}R^{C}, S═O, and C═O;
when present, Y is, independently at each occurrence, selected from NR^{A}, O, S, CR^{B}R^{C}, and C═O;
wherein, when Y is present, at least one of X and Y is CR^{B}R^{C} or C═O;
R^{A} is, independently at each occurrence, selected from H, alkyl, —O-alkyl, or haloalkyl;
R^{B} and R^{C} are, independently at each occurrence, selected from H, OH, SH, halo, amine, alkyl, —(H)C═O, —O-alkyl, and haloalkyl;
or R^{B} and R^{C}, together with the atom to which they are attached, form a cycloalkyl, cycloalkenyl, heterocycloalkenyl, or heterocycloalkyl, which is optionally substituted with one or more R^{G}, wherein R^{G} is selected from H, alkyl, alkyoxyl, and hydroxyl;
n is 0 or 1; and
--- represents an optional bond.

In certain embodiments, polymers of the present disclosure comprise a plurality of repeat units of Formula I.

In certain embodiments, polymers of the disclosure comprise a unit of Formula Ia:

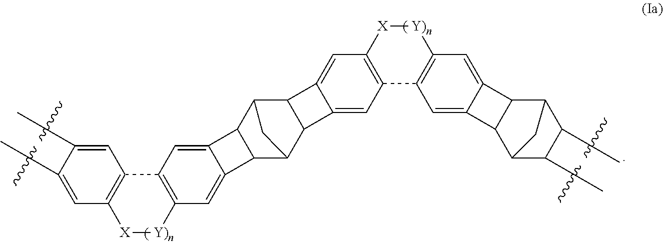

In certain embodiments, the polymer further comprise another co-monomer.

In certain embodiments, the at least one unit of Formula I is a unit of Formula II:

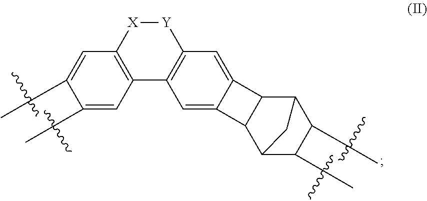

In certain embodiments, the at least one unit of Formula II is a unit of Formula IIa:

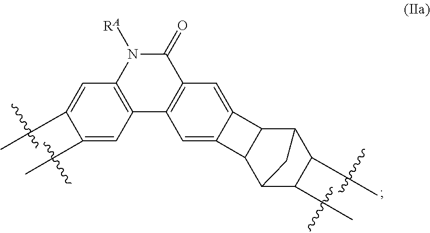

In further embodiments, R^{A} is H or alkyl. In yet further embodiments, the at least one unit of Formula II is a unit of Formula IIb:

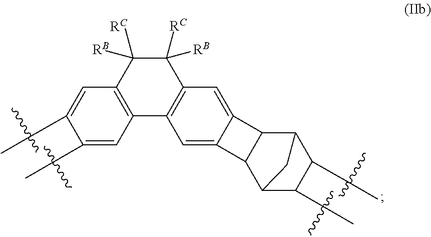

In still further embodiments, the at least one unit of Formula II is selected from:

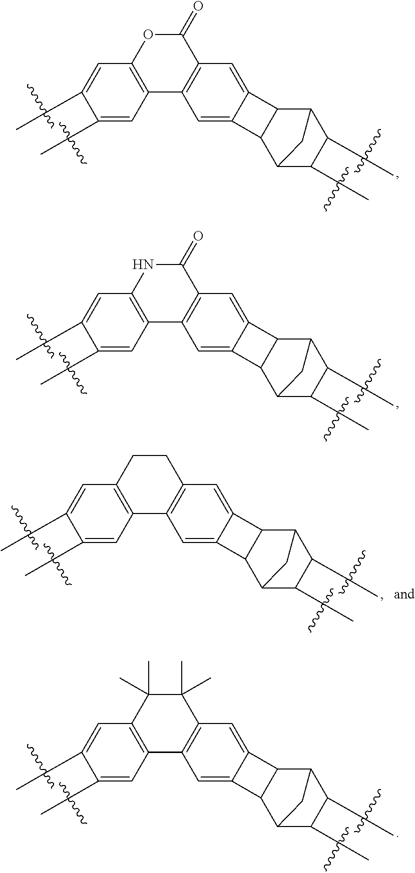

In certain embodiments, the at least one unit of Formula I is a unit of Formula III:

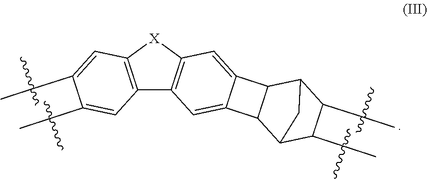

In further embodiments, the at least one unit of Formula III is a unit of Formula IIIb:

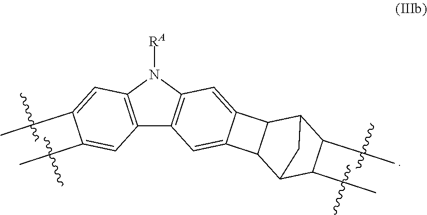

In yet further embodiments, R^{A} is H or alkyl.

In still further embodiments, the at least one unit of Formula III is a unit of Formula IIIc.

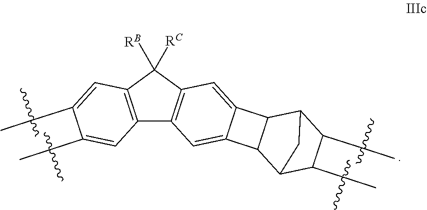

In certain embodiments, R^{B} and R^{C}, together with the atom to which they are attached, form a heterocycloalkyl. In further embodiments, R^{B} and R^{C} are, independently at each occurrence, alkyl or fluoroalkyl. R^{B} and R^{C} are each H. In yet further embodiments, the at least one unit of Formula III is selected from:

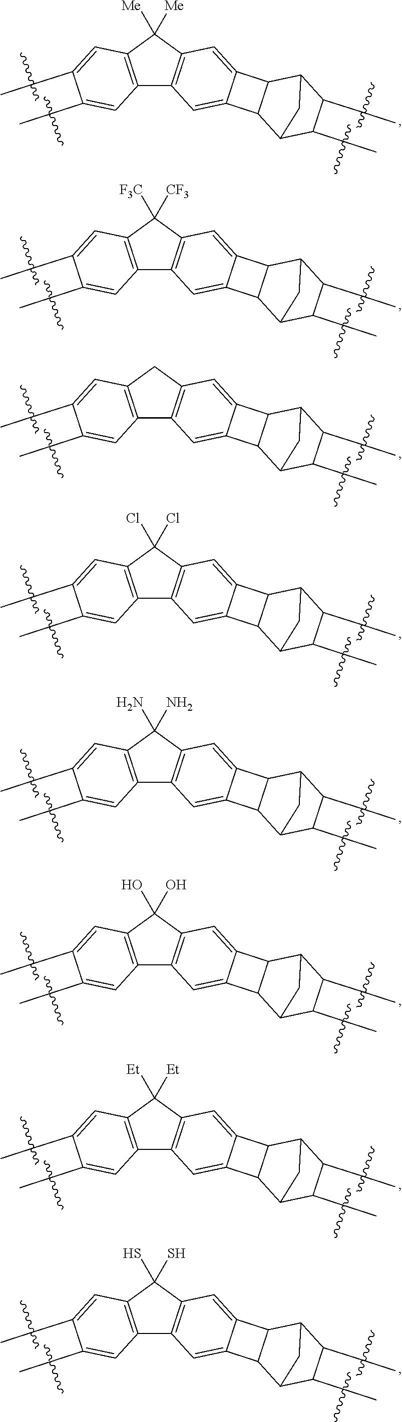

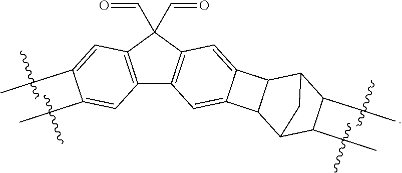

In certain embodiments, the at least one unit of Formula III is a unit of Formula IIId,

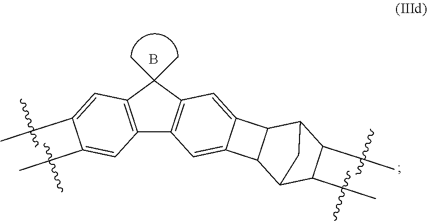

wherein Ring B is a cycloalkyl, cycloalkenyl, heterocycloalkenyl, or heterocycloalkyl, which is optionally substituted with one or more R^{G}, wherein R^{G} is selected from H, alkyl, alkyoxyl, and hydroxyl.

In further embodiments, Ring B is a five- or six-membered ring. In yet further embodiments, Ring B is selected from cyclopentane, cyclohexane, tetrahydropyran, dioxolane, dioxane, dithiolane, pyrimidine, and 3,4-dihydro-2H-pyrrole; and Ring B is optionally substituted with one or more R^{G}.

In certain embodiments, the at least one unit of Formula III is selected from:

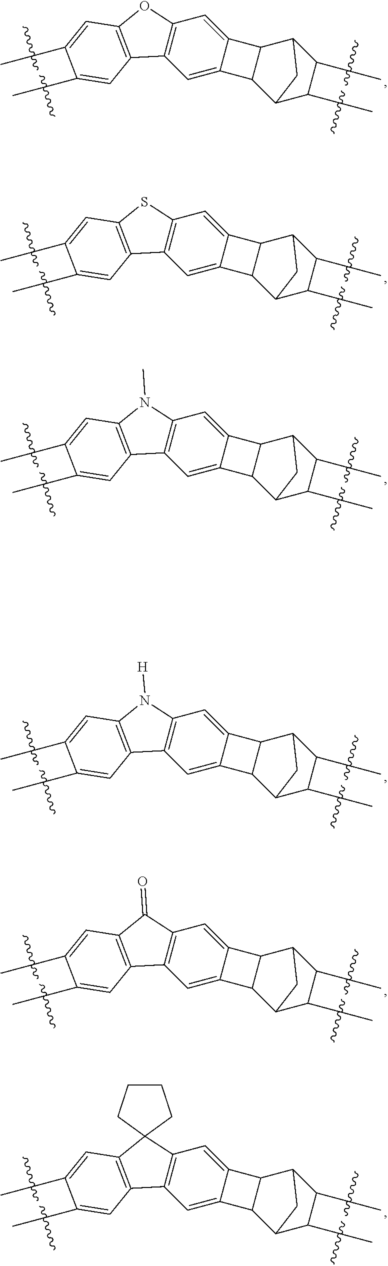

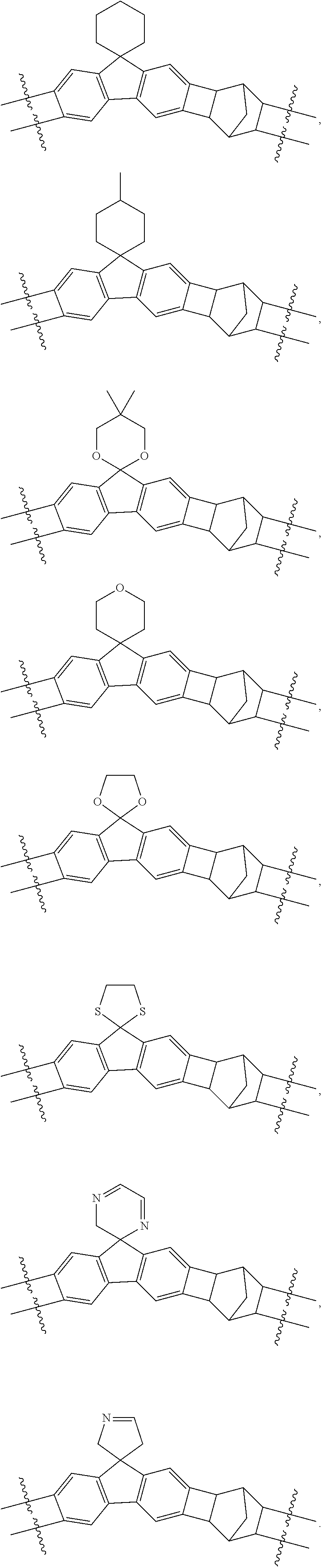

In certain embodiments, the at least one unit of Formula I is a unit of Formula IV:

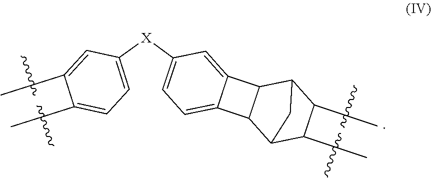

In further embodiments, the at least one unit of Formula IV is a unit of Formula IVa:

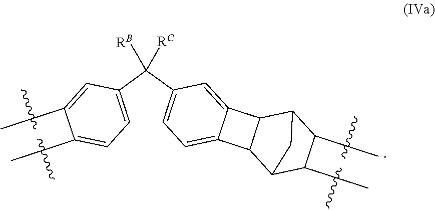

In yet further embodiments, the at least one unit of Formula IV is selected from:

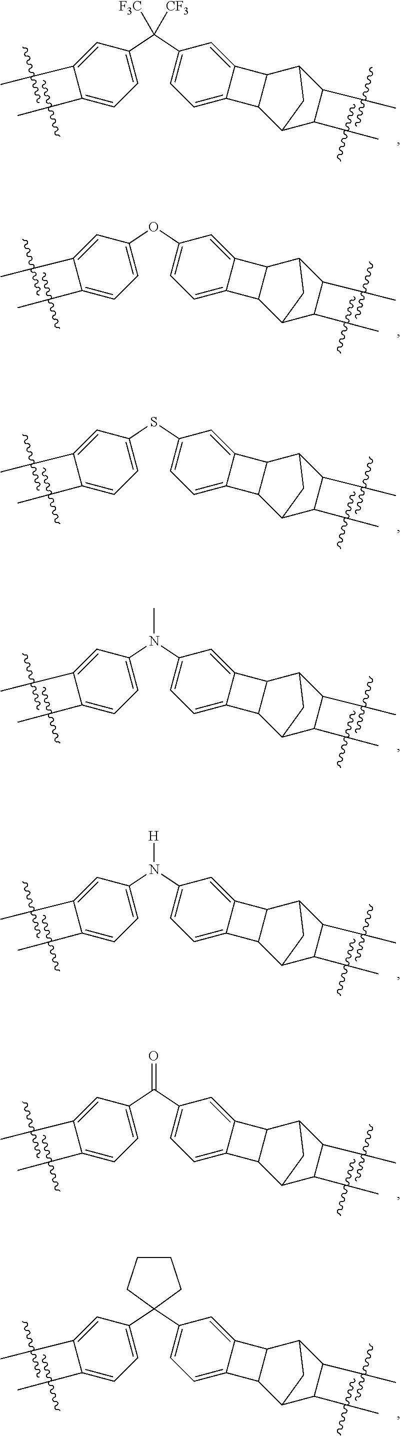

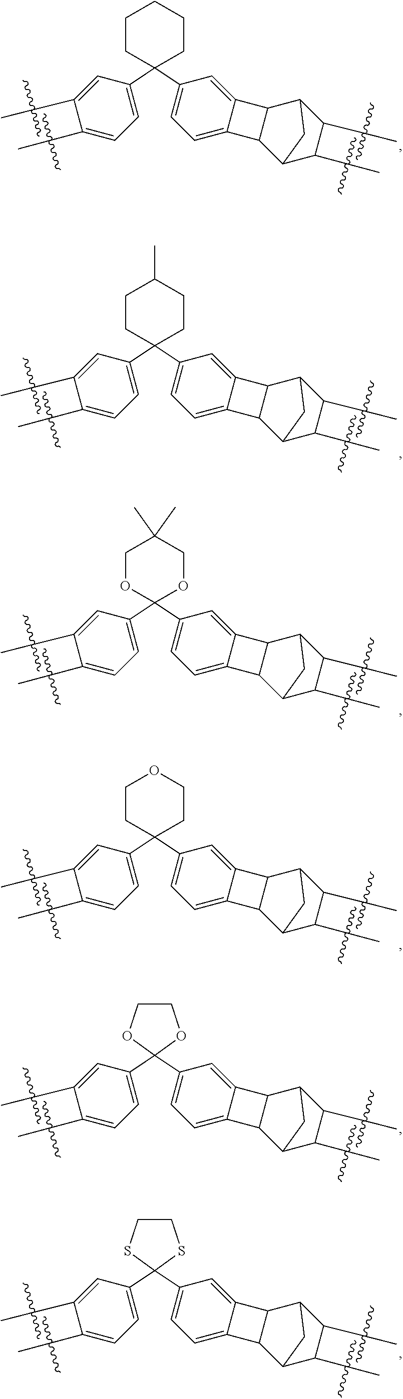

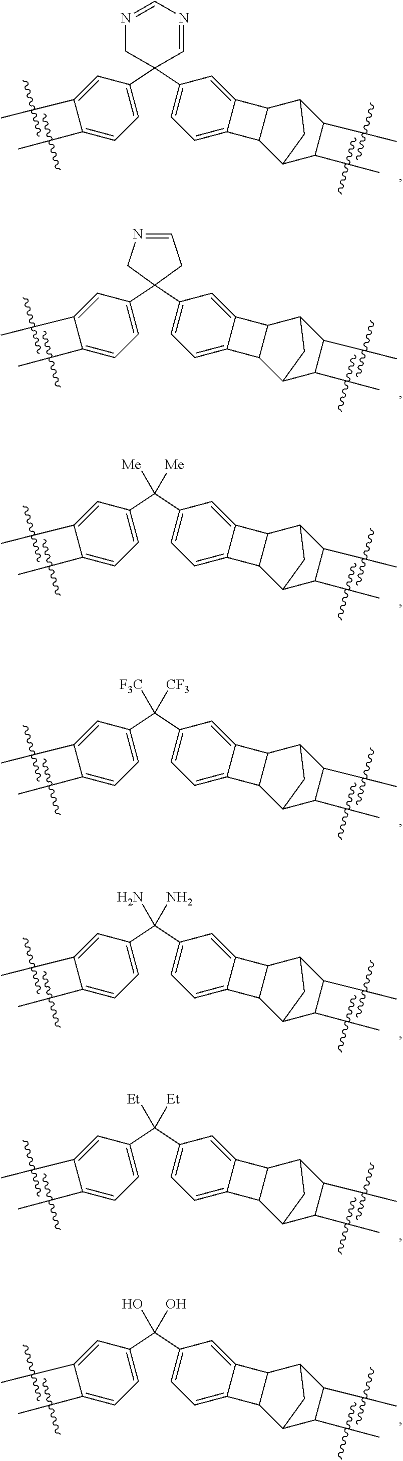

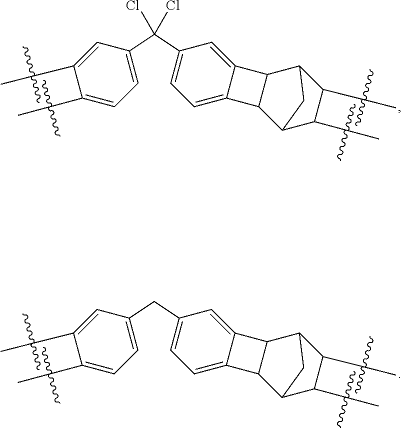

In certain embodiments, the at least one unit of Formula I is a unit of Formula V:

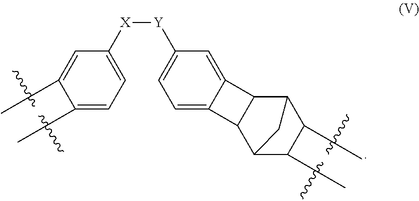

In further embodiments, the at least one unit of Formula V is selected from:

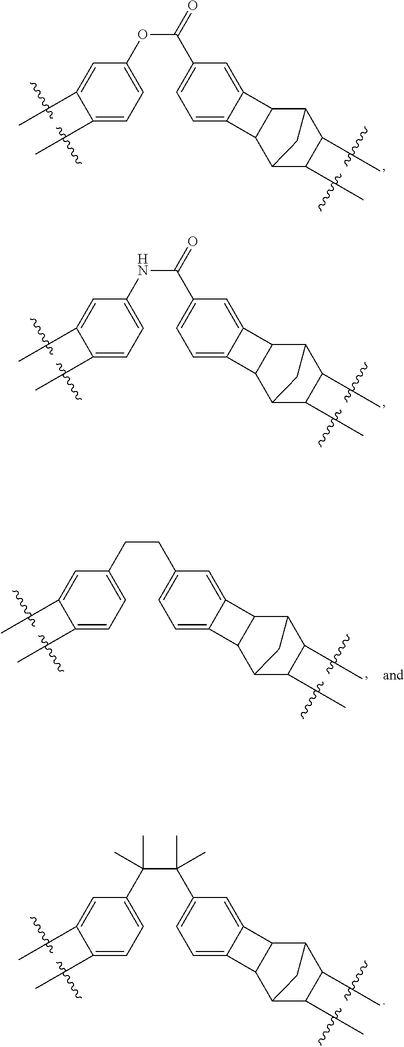

In certain embodiments, the polymer comprises over 20 units. In further embodiments, the polymer comprises over 20 units of Formula I. In yet further embodiments, the polymer has a weight average molecular weight (MW) of greater than 100,000 g. In still further embodiments, the polymer has a glass transition temperature (TG) that is greater than its decomposition temperature.

### Methods of Separating Fluids

The polymer membranes of the present disclosure can be used in various art-recognized fluid separation methods. Non-limiting examples of such methods may be found in International Application WO 2021/101659, which is expressly incorporated by reference herein.

In certain aspects, provided herein are methods of separating mixtures of fluids comprising passing a mixture of fluids through a separation membrane comprising a polymer of the disclosure. In certain embodiments, the mixture of fluids comprises CO₂/CH₄, H₂/CH₄, H₂/N₂, and H₂/CO₂.

Said methods may be performed on a constant-volume variable-pressure apparatus at 35° C. and 1 bar upstream pressure, unless otherwise stated. Before permeation experiments, polymer films may be heated at 120° C. under vacuum for 24 h or heated at 120° C. under vacuum for 24 h and then soaked in liquid methanol for 24 h. The films may then be masked with epoxy on brass support and further degassed at 35° C. under high vacuum(<0.02 Torr) for 8 h in the permeation apparatus. Variable-temperature pure-gas permeation experiments may be performed at 25° C., 35° C., 45° C., and 55° C.

### Methods of Making Ladder Polymers

In yet further aspects, provided herein are methods of making polymers of the disclosure. In certain embodiments, the method comprises:
reacting a compound of Formula Ia:

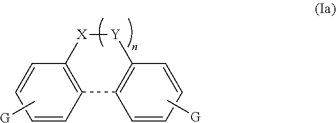

wherein each G is independently a halide or pseudohalide, such as a triflate, nonaflate, tosylate, or methanesulfonate;
   with norbornadiene in the presence of a palladium catalyst, a ligand, and a base.

In further embodiments, the palladium catalyst is a palladium(II) salt, an organometallic palladium(II) complex, or a palladium(0) compound. In yet further embodiments, the palladium catalyst is selected from G4 palladium dimer, Pd(OAc)₂, and Pd₂(dba)₃. In still further embodiments, the ligand is a phosphine, a phosphite, or a carbene. In certain embodiments, the ligand is selected from ^{t}BuPCy₂, Cy₂P(^{t}Bu)₂·HBF₄, Ad₂P(n-Bu), XPhos, DavePhos, SPhos, RuPhos, BrettPhos, tBuXPhos, XantPhos, dialkylarylbiarylphosphines, and tris-arylphosphines, such as PPh₃. In further embodiments, the ligand is an N-Heterocyclic Carbene. In yet further embodiments, the ligand is an imidazolylidene, such as IPr, IMes, sIPr, SIPr, SIMes. In still further embodiments, the base is a carbonate base, a tribasic phosphate base, a phenoxide base, or a tert-butoxide base. In certain embodiments, the base is Cs₂CO₃.

In certain aspects, provided herein are methods of making a polymer, the polymer comprising at least one unit of Formula X:

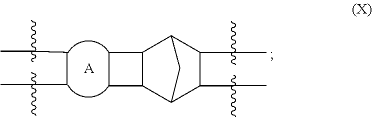

wherein A is a moiety comprising at least two aromatic rings;
wherein the method comprises reacting a compound of formula Xa:

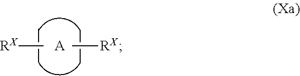

wherein R^{X} is a halide or pseudohalide, such as a triflate, nonaflate, tosylate, or methanesulfonate;
with norbornadiene, in the presence of a palladium catalyst, a ligand, and a base.

In further embodiments, the compound of formula Xa is selected from:

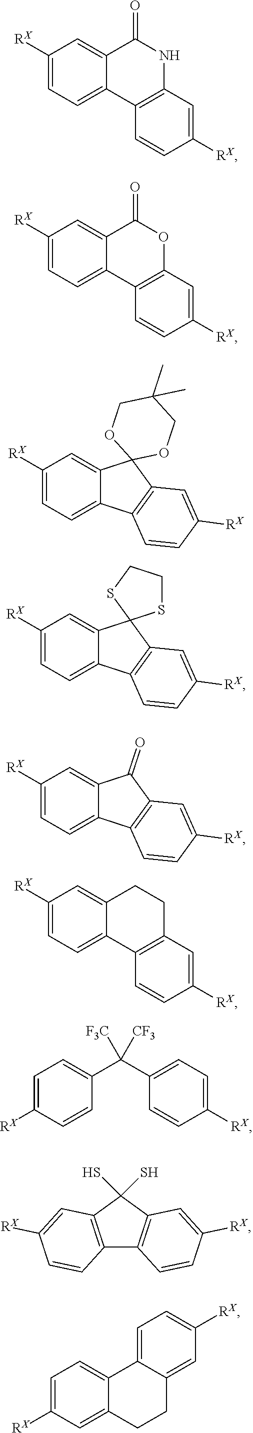

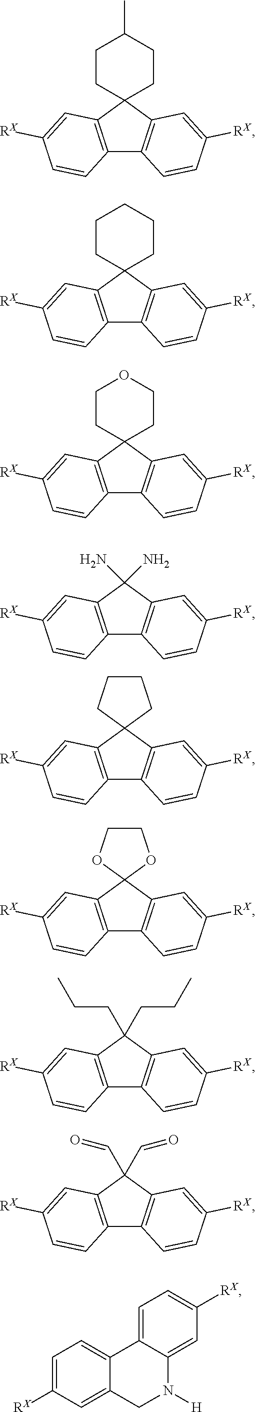

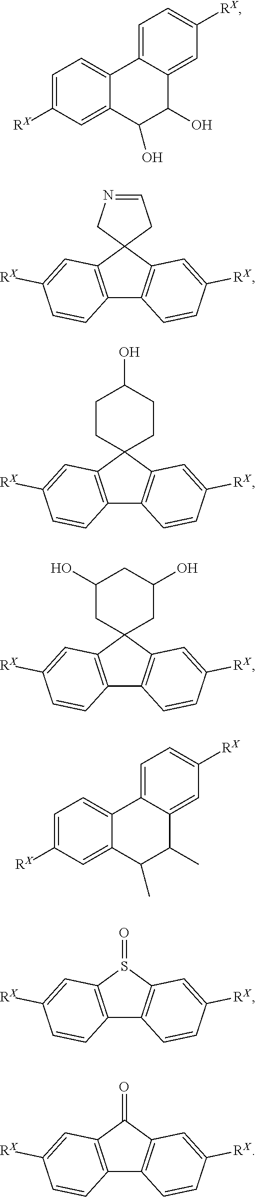

### Definitions

Unless otherwise defined herein, scientific and technical terms used in this application shall have the meanings that are commonly understood by those of ordinary skill in the art. Generally, nomenclature used in connection with, and techniques of, chemistry described herein, are those well known and commonly used in the art.

The methods and techniques of the present disclosure are generally performed, unless otherwise indicated, according to conventional methods well known in the art and as described in various general and more specific references that are cited and discussed throughout this specification.

Chemistry terms used herein, unless otherwise defined herein, are used according to conventional usage in the art, as exemplified by “The McGraw-Hill Dictionary of Chemical Terms”, Parker S., Ed., McGraw-Hill, San Francisco, C.A. (1985).

All of the above, and any other publications, patents and published patent applications referred to in this application are specifically incorporated by reference herein. In case of conflict, the present specification, including its specific definitions, will control.

As used herein, the terms “optional” or “optionally” mean that the subsequently described event or circumstance may occur or may not occur, and that the description includes instances where the event or circumstance occurs as well as instances in which it does not. For example, “optionally substituted alkyl” refers to the alkyl may be substituted as well as where the alkyl is not substituted.

It is understood that substituents and substitution patterns on the compounds of the present invention can be selected by one of ordinary skilled person in the art to result chemically stable compounds which can be readily synthesized by techniques known in the art, as well as those methods set forth below, from readily available starting materials. If a substituent is itself substituted with more than one group, it is understood that these multiple groups may be on the same carbon or on different carbons, so long as a stable structure results.

As used herein, the term “optionally substituted” refers to the replacement of one to six hydrogen radicals in a given structure with the radical of a specified substituent including, but not limited to: hydroxyl, hydroxyalkyl, alkoxy, halogen, alkyl, nitro, silyl, acyl, acyloxy, aryl, cycloalkyl, heterocyclyl, amino, aminoalkyl, cyano, haloalkyl, haloalkoxy, —OCO—CH₂—O-alkyl, —OP(O)(O-alkyl)₂ or —CH₂—OP(O)(O-alkyl)₂. Preferably, “optionally substituted” refers to the replacement of one to four hydrogen radicals in a given structure with the substituents mentioned above. More preferably, one to three hydrogen radicals are replaced by the substituents as mentioned above. It is understood that the substituent can be further substituted.

As used herein, the term “alkyl” refers to saturated aliphatic groups, including but not limited to C₁-C₁₀ straight-chain alkyl groups or C₁-C₁₀ branched-chain alkyl groups. Preferably, the “alkyl” group refers to C₁-C₆ straight-chain alkyl groups or C₁-C₆ branched-chain alkyl groups. Most preferably, the “alkyl” group refers to C₁-C₄ straight-chain alkyl groups or C₁-C₄ branched-chain alkyl groups. Examples of “alkyl” include, but are not limited to, methyl, ethyl, 1-propyl, 2-propyl, n-butyl, sec-butyl, tert-butyl, 1-pentyl, 2-pentyl, 3-pentyl, neo-pentyl, 1-hexyl, 2-hexyl, 3-hexyl, 1-heptyl, 2-heptyl, 3-heptyl, 4-heptyl, 1-octyl, 2-octyl, 3-octyl or 4-octyl and the like. The “alkyl” group may be optionally substituted.

The term “acyl” is art-recognized and refers to a group represented by the general formula hydrocarbylC(O)—, preferably alkylC(O)—.

The term “acylamino” is art-recognized and refers to an amino group substituted with an acyl group and may be represented, for example, by the formula hydrocarbylC(O)NH—.

The term “acyloxy” is art-recognized and refers to a group represented by the general formula hydrocarbylC(O)O—, preferably alkylC(O)O—.

The term “alkoxy” refers to an alkyl group having an oxygen attached thereto. Representative alkoxy groups include methoxy, ethoxy, propoxy, tert-butoxy and the like.

The term “alkoxyalkyl” refers to an alkyl group substituted with an alkoxy group and may be represented by the general formula alkyl-O-alkyl.

The term “alkyl” refers to saturated aliphatic groups, including straight-chain alkyl groups, branched-chain alkyl groups, cycloalkyl (alicyclic) groups, alkyl-substituted cycloalkyl groups, and cycloalkyl-substituted alkyl groups. In preferred embodiments, a straight chain or branched chain alkyl has 30 or fewer carbon atoms in its backbone (e.g., C₁₋₃₀ for straight chains, C₃₋₃₀ for branched chains), and more preferably 20 or fewer.

Moreover, the term “alkyl” as used throughout the specification, examples, and claims is intended to include both unsubstituted and substituted alkyl groups, the latter of which refers to alkyl moieties having substituents replacing a hydrogen on one or more carbons of the hydrocarbon backbone, including haloalkyl groups such as trifluoromethyl and 2,2,2-trifluoroethyl, etc.

The term “C_{x-y}” or “Cₓ-C_{y}”, when used in conjunction with a chemical moiety, such as, acyl, acyloxy, alkyl, alkenyl, alkynyl, or alkoxy is meant to include groups that contain from x to y carbons in the chain. C₀alkyl indicates a hydrogen where the group is in a terminal position, a bond if internal. A C₁₋₆alkyl group, for example, contains from one to six carbon atoms in the chain.

The term “alkylamino”, as used herein, refers to an amino group substituted with at least one alkyl group.

The term “alkylthio”, as used herein, refers to a thiol group substituted with an alkyl group and may be represented by the general formula alkylS—.

The term “amide”, as used herein, refers to a group

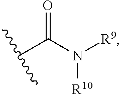

wherein R⁹ and R¹⁰ each independently represent a hydrogen or hydrocarbyl group, or R⁹ and R¹⁰ taken together with the N atom to which they are attached complete a heterocycle having from 4 to 8 atoms in the ring structure.

The terms “amine” and “amino” are art-recognized and refer to both unsubstituted and substituted amines and salts thereof, e.g., a moiety that can be represented by

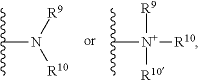

wherein R⁹, R¹⁰ and R¹⁰′, each independently represent a hydrogen or a hydrocarbyl group, or R⁹ and R¹⁰ taken together with the N atom to which they are attached complete a heterocycle having from 4 to 8 atoms in the ring structure.

The term “aminoalkyl”, as used herein, refers to an alkyl group substituted with an amino group.

The term “aralkyl”, as used herein, refers to an alkyl group substituted with an aryl group.

The term “aryl” as used herein include substituted or unsubstituted single-ring aromatic groups in which each atom of the ring is carbon. Preferably the ring is a 5- to 7-membered ring, more preferably a 6-membered ring. The term “aryl” also includes polycyclic ring systems having two or more cyclic rings in which two or more carbons are common to two adjoining rings wherein at least one of the rings is aromatic, e.g., the other cyclic rings can be cycloalkyls, cycloalkenyls, cycloalkynyls, aryls, heteroaryls, and/or heterocyclyls. Aryl groups include benzene, naphthalene, phenanthrene, phenol, aniline, and the like.

The term “carbamate” is art-recognized and refers to a group

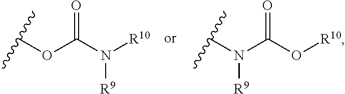

wherein R⁹ and R¹⁰ independently represent hydrogen or a hydrocarbyl group.

The term “carbocyclylalkyl”, as used herein, refers to an alkyl group substituted with a carbocycle group.

The term “carbocycle” includes 5-7 membered monocyclic and 8-12 membered bicyclic rings. Each ring of a bicyclic carbocycle may be selected from saturated, unsaturated and aromatic rings. Carbocycle includes bicyclic molecules in which one, two or three or more atoms are shared between the two rings. The term “fused carbocycle” refers to a bicyclic carbocycle in which each of the rings shares two adjacent atoms with the other ring. Each ring of a fused carbocycle may be selected from saturated, unsaturated and aromatic rings. In an exemplary embodiment, an aromatic ring, e.g., phenyl, may be fused to a saturated or unsaturated ring, e.g., cyclohexane, cyclopentane, or cyclohexene. Any combination of saturated, unsaturated and aromatic bicyclic rings, as valence permits, is included in the definition of carbocyclic. Exemplary “carbocycles” include cyclopentane, cyclohexane, bicyclo[2.2.1]heptane, 1,5-cyclooctadiene, 1,2,3,4-tetrahydronaphthalene, bicyclo[4.2.0]oct-3-ene, naphthalene and adamantane. Exemplary fused carbocycles include decalin, naphthalene, 1,2,3,4-tetrahydronaphthalene, bicyclo[4.2.0]octane, 4,5,6,7-tetrahydro-1H-indene and bicyclo[4.1.0]hept-3-ene. “Carbocycles” may be substituted at any one or more positions capable of bearing a hydrogen atom.

The term “carbocyclylalkyl”, as used herein, refers to an alkyl group substituted with a carbocycle group.

The term “carbonate” is art-recognized and refers to a group —OCO₂—.

The term “carboxy”, as used herein, refers to a group represented by the formula —CO₂H.

The term “cycloalkyl” includes substituted or unsubstituted non-aromatic single ring structures, preferably 4- to 8-membered rings, more preferably 4- to 6-membered rings. The term “cycloalkyl” also includes polycyclic ring systems having two or more cyclic rings in which two or more carbons are common to two adjoining rings wherein at least one of the rings is cycloalkyl and the substituent (e.g., R¹⁰⁰) is attached to the cycloalkyl ring, e.g., the other cyclic rings can be cycloalkyls, cycloalkenyls, cycloalkynyls, aryls, heteroaryls, and/or heterocyclyls. Heteroaryl groups include, for example, pyrrole, furan, thiophene, imidazole, oxazole, thiazole, pyrazole, pyridine, pyrazine, pyridazine, pyrimidine, denzodioxane, tetrahydroquinoline, and the like.

The term “ester”, as used herein, refers to a group —C(O)OR⁹ wherein R⁹ represents a hydrocarbyl group.

The term “ether”, as used herein, refers to a hydrocarbyl group linked through an oxygen to another hydrocarbyl group. Accordingly, an ether substituent of a hydrocarbyl group may be hydrocarbyl-O—. Ethers may be either symmetrical or unsymmetrical. Examples of ethers include, but are not limited to, heterocycle-O-heterocycle and aryl-O-heterocycle. Ethers include “alkoxyalkyl” groups, which may be represented by the general formula alkyl-O-alkyl.

The terms “halo” and “halogen” as used herein means halogen and includes chloro, fluoro, bromo, and iodo.

The terms “hetaralkyl” and “heteroaralkyl”, as used herein, refers to an alkyl group substituted with a hetaryl group.

The terms “heteroaryl” and “hetaryl” include substituted or unsubstituted aromatic single ring structures, preferably 5- to 7-membered rings, more preferably 5- to 6-membered rings, whose ring structures include at least one heteroatom, preferably one to four heteroatoms, more preferably one or two heteroatoms. The terms “heteroaryl” and “hetaryl” also include polycyclic ring systems having two or more cyclic rings in which two or more carbons are common to two adjoining rings wherein at least one of the rings is heteroaromatic, e.g., the other cyclic rings can be cycloalkyls, cycloalkenyls, cycloalkynyls, aryls, heteroaryls, and/or heterocyclyls. Heteroaryl groups include, for example, pyrrole, furan, thiophene, imidazole, oxazole, thiazole, pyrazole, pyridine, pyrazine, pyridazine, and pyrimidine, and the like.

The term “heteroatom” as used herein means an atom of any element other than carbon or hydrogen. Preferred heteroatoms are nitrogen, oxygen, and sulfur.

The term “heterocyclylalkyl”, as used herein, refers to an alkyl group substituted with a heterocycle group.

The terms “heterocyclyl”, “heterocycle”, and “heterocyclic” refer to substituted or unsubstituted non-aromatic ring structures, preferably 3- to 10-membered rings, more preferably 3- to 7-membered rings, whose ring structures include at least one heteroatom, preferably one to four heteroatoms, more preferably one or two heteroatoms. The terms “heterocyclyl” and “heterocyclic” also include polycyclic ring systems having two or more cyclic rings in which two or more carbons are common to two adjoining rings wherein at least one of the rings is heterocyclic, e.g., the other cyclic rings can be cycloalkyls, cycloalkenyls, cycloalkynyls, aryls, heteroaryls, and/or heterocyclyls. Heterocyclyl groups include, for example, piperidine, piperazine, pyrrolidine, morpholine, lactones, lactams, and the like.

The term “hydrocarbyl”, as used herein, refers to a group that is bonded through a carbon atom that does not have a ═O or ═S substituent, and typically has at least one carbon-hydrogen bond and a primarily carbon backbone, but may optionally include heteroatoms. Thus, groups like methyl, ethoxyethyl, 2-pyridyl, and even trifluoromethyl are considered to be hydrocarbyl for the purposes of this application, but substituents such as acetyl (which has a ═O substituent on the linking carbon) and ethoxy (which is linked through oxygen, not carbon) are not. Hydrocarbyl groups include, but are not limited to aryl, heteroaryl, carbocycle, heterocycle, alkyl, alkenyl, alkynyl, and combinations thereof.

The term “hydroxyalkyl”, as used herein, refers to an alkyl group substituted with a hydroxy group.

The term “lower” when used in conjunction with a chemical moiety, such as, acyl, acyloxy, alkyl, alkenyl, alkynyl, or alkoxy is meant to include groups where there are ten or fewer atoms in the substituent, preferably six or fewer. A “lower alkyl”, for example, refers to an alkyl group that contains ten or fewer carbon atoms, preferably six or fewer. In certain embodiments, acyl, acyloxy, alkyl, alkenyl, alkynyl, or alkoxy substituents defined herein are respectively lower acyl, lower acyloxy, lower alkyl, lower alkenyl, lower alkynyl, or lower alkoxy, whether they appear alone or in combination with other substituents, such as in the recitations hydroxyalkyl and aralkyl (in which case, for example, the atoms within the aryl group are not counted when counting the carbon atoms in the alkyl substituent).

The terms “polycyclyl”, “polycycle”, and “polycyclic” refer to two or more rings (e.g., cycloalkyls, cycloalkenyls, cycloalkynyls, aryls, heteroaryls, and/or heterocyclyls) in which two or more atoms are common to two adjoining rings, e.g., the rings are “fused rings”. Each of the rings of the polycycle can be substituted or unsubstituted. In certain embodiments, each ring of the polycycle contains from 3 to 10 atoms in the ring, preferably from 5 to 7.

The term “sulfate” is art-recognized and refers to the group —OSO₃H, or a pharmaceutically acceptable salt thereof.

The term “sulfonamide” is art-recognized and refers to the group represented by the general formulae

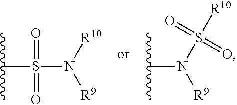

wherein R⁹ and R¹⁰ independently represents hydrogen or hydrocarbyl.

The term “sulfoxide” is art-recognized and refers to the group-S(O)—.

The term “sulfonate” is art-recognized and refers to the group SO₃H, or a pharmaceutically acceptable salt thereof.

The term “sulfone” is art-recognized and refers to the group —S(O)₂—.

The term “substituted” refers to moieties having substituents replacing a hydrogen on one or more carbons of the backbone. It will be understood that “substitution” or “substituted with” includes the implicit proviso that such substitution is in accordance with permitted valence of the substituted atom and the substituent, and that the substitution results in a stable compound, e.g., which does not spontaneously undergo transformation such as by rearrangement, cyclization, elimination, etc. As used herein, the term “substituted” is contemplated to include all permissible substituents of organic compounds. In a broad aspect, the permissible substituents include acyclic and cyclic, branched and unbranched, carbocyclic and heterocyclic, aromatic and non-aromatic substituents of organic compounds. The permissible substituents can be one or more and the same or different for appropriate organic compounds. For purposes of this invention, the heteroatoms such as nitrogen may have hydrogen substituents and/or any permissible substituents of organic compounds described herein which satisfy the valences of the heteroatoms. Substituents can include any substituents described herein, for example, a halogen, a hydroxyl, a carbonyl (such as a carboxyl, an alkoxycarbonyl, a formyl, or an acyl), a thiocarbonyl (such as a thioester, a thioacetate, or a thioformate), an alkoxyl, a phosphoryl, a phosphate, a phosphonate, a phosphinate, an amino, an amido, an amidine, an imine, a cyano, a nitro, an azido, a sulfhydryl, an alkylthio, a sulfate, a sulfonate, a sulfamoyl, a sulfonamido, a sulfonyl, a heterocyclyl, an aralkyl, or an aromatic or heteroaromatic moiety. It will be understood by those skilled in the art that the moieties substituted on the hydrocarbon chain can themselves be substituted, if appropriate.

The term “thioalkyl”, as used herein, refers to an alkyl group substituted with a thiol group.

The term “thioester”, as used herein, refers to a group —C(O)SR⁹ or —SC(O)R⁹ wherein R⁹ represents a hydrocarbyl.

The term “thioether”, as used herein, is equivalent to an ether, wherein the oxygen is replaced with a sulfur.

The term “urea” is art-recognized and may be represented by the general formula

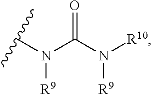

wherein R⁹ and R¹⁰ independently represent hydrogen or a hydrocarbyl.

Some of the compounds useful in the methods and compositions of this disclosure have at least one stereogenic center in their structure. This stereogenic center may be present in a R or a S configuration, said R and S notation is used in correspondence with the rules described in Pure Appl. Chem. (1976), 45, 11-30. The disclosure contemplates all stereoisomeric forms such as enantiomeric and diastereoisomeric forms of the compounds, salts, prodrugs or mixtures thereof (including all possible mixtures of stereoisomers). See, e.g., WO 01/062726.

Furthermore, certain compounds which contain alkenyl groups may exist as Z (zusammen) or E (entgegen) isomers. In each instance, the disclosure includes both mixture and separate individual isomers.

Some of the compounds may also exist in tautomeric forms. Such forms, although not explicitly indicated in the formulae described herein, are intended to be included within the scope of the present disclosure.

The term “Log of solubility”, “Log S” or “log S” as used herein is used in the art to quantify the aqueous solubility of a compound. The aqueous solubility of a compound significantly affects its absorption and distribution characteristics. A low solubility often goes along with a poor absorption. Log S value is a unit stripped logarithm (base 10) of the solubility measured in mol/liter.

The term “weight average molecular weight,” also abbreviated in some instances as M_{W}, as used herein refers to the sum of the molecular weights of each polymer chain in a mixture of polymer chains, divided by the total number of chains in the mixture.

The term “glass transition temperature” or “T_{G}” as used herein refers to the temperature or range of temperatures at which a polymer or mixture of polymers undergoes a phase transition from a “glassy” or amorphous solid state to a viscous liquid or semi-liquid state. In some embodiments, this transition may also be characterized by a decrease in the brittle nature of the glassy material.

The term “decomposition temperature” as used herein refers to the temperature at which a substance, e.g., a polymer of the disclosure, begins to decompose or undergo a chemical change to the composition of the substance.

The terms “statistical mixture” and “statistical copolymer” refer to copolymers in which the sequential distribution of the monomeric units obeys known statistical laws, e.g., the monomer sequence distribution may follow Markovian statistics of zeroth (Bernoullian), first, second, or higher order. The elementary processes leading to the formation of a statistical sequence of monomeric units do not necessarily proceed with equal apriori probability. These processes may, in some embodiments, lead to various types of sequence distribution comprising those in which the arrangement of monomeric units tends toward alternation, tends toward clustering of like units, or exhibits no ordering tendency at all. These terms may be used interchangeably herein.

As used herein, the term “Monomer” may refer to a sub-unit which is either present in a precursor form (e.g., a dihalide-substituted precursor) or is incorporated into a polymer's structure (e.g., units of Formula I may be referred to as monomers).

The term “dispersity,” (abbreviated D) is art-recognized, and is used herein is a measure of the distribution of sizes (e.g., molecular weight, chain length) in a mixture of polymers. This quantity can also be referred to as the polydispersity index, or PDI.

### EXAMPLES

The invention now being generally described, it will be more readily understood by reference to the following examples which are included merely for purposes of illustration of certain aspects and embodiments of the present invention, and are not intended to limit the invention.

### Example 1: Exemplary Polymerization Procedure

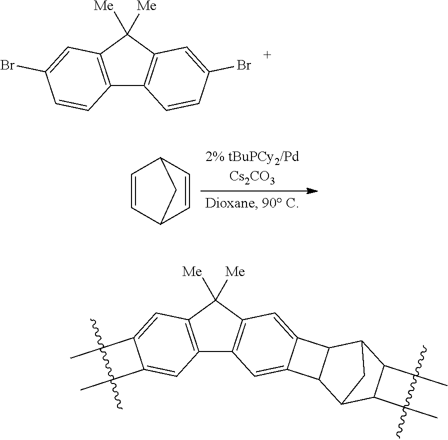

A 15 mL screw-top pressure tube equipped with a magnetic stir bar and Teflon screw cap was charged with 2,7-dibromo-9,9-dimethylfluorene (704 mg, 2 mmol, 1 equiv), G4 palladium dimer (31 mg, 0.08 mmol, 2 mol %) and tBuPCy₂·HBF₄ (28 mg, 0.08 mmol, 2 mol %). The reaction tube was brought into a nitrogen filled glovebox and cesium carbonate (1.43 g, 4.4 mmol, 1.1 equiv.) was added followed by norbornadiene (203 μL, 2 mmol, 1 equiv.) and 1,4-dioxane (4 mL) by syringe. The pressure tube was capped, removed from the glove box, and stirred in a preheated oil bath at 90° C. until the reaction mixture was very viscous and near-solid (typically ˜8 hours). The reaction mixture was then removed from heat, diluted with chloroform (10 mL) and stirred for 15 minutes. The mixture was then filtered through a pad of celite, rinsing with additional chloroform, and the solvent fully removed via rotary evaporation. The polymer was redissolved in the minimum amount of chloroform and precipitated into ethyl acetate with vigorous stirring. The solid was then filtered and dried under vacuum to provide the title polymer as a yellow solid. Yield: 434 mg, 77%, SEC (CHC₃, RI): M_{w}=115 kDa, Ð=16.3, ¹H NMR (500 MHz, CDCl₃) δ 7.37 (s, 2H), 7.09 (s, 2H), 3.49-3.15 (m, 4H), 2.42 (d, J=30.4 Hz, 2H), 1.47 (d, J=18.4 Hz, 6H), 0.84 (s, 2H) ppm.

### Example 2: Exemplary Polymerization of Aryl Chlorides

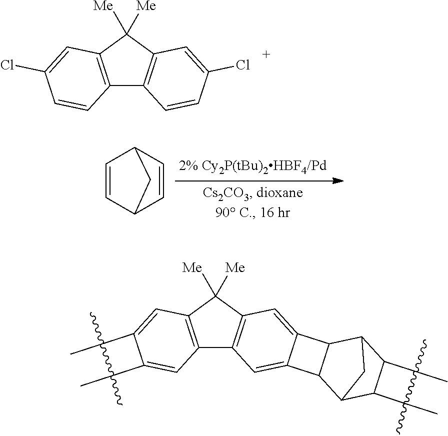

A 15 mL screw-top pressure tube equipped with a magnetic stir bar and Teflon screw cap was charged with 2,7-dichloro-9,9-dimethylfluorene (526 mg, 2 mmol, 1 equiv), G4 palladium dimer (31 mg, 0.08 mmol, 2 mol %) and tBuPCy₂·HBF₄ (28 mg, 0.08 mmol, 2 mol %). The reaction tube was brought into a nitrogen filled glovebox and cesium carbonate (1.43 g, 4.4 mmol, 1.1 equiv.) was added followed by norbornadiene (203 μL, 2 mmol, 1 equiv.) and 1,4-dioxane (4 mL) by syringe. The pressure tube was capped, removed from the glove box, and stirred in a preheated oil bath at 90° C. until the reaction mixture was very viscous and near-solid (typically ˜8 hours). The reaction mixture was then removed from heat, diluted with chloroform (10 mL) and stirred for 15 minutes. The mixture was then filtered through a pad of celite, rinsing with additional chloroform, and the solvent fully removed via rotary evaporation. The polymer was redissolved in the minimum amount of chloroform and precipitated into ethyl acetate with vigorous stirring. The solid was then filtered and dried under vacuum to provide the title polymer as a yellow solid. Yield: 391 mg, 69%, SEC (CHCl₃, RI): M_{w}=32 kDa, Ð=4.4, ¹H NMR: Same as given in Example 1.

### Example 3: Exemplary Polymerization of Aryl Chlorides and Dinorbornene

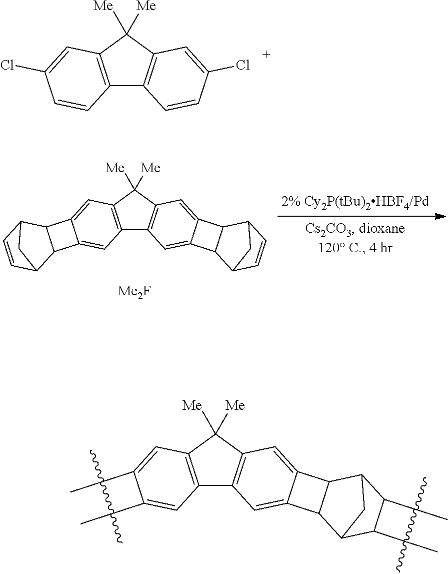

A 15 mL screw-top pressure tube equipped with a magnetic stir bar and Teflon screw cap was charged with 2,7-dichloro-9,9-dimethylfluorene (132 mg, 0.5 mmol, 1 equiv.), Me₂F monomer (187 mg, 0.5 mmol, 1 equiv.), G4 palladium dimer (7.6 mg, 0.02 mmol, 2 mol %) and tBuPCy₂·HBF₄ (7 mg, 0.02 mmol, 2 mol %). The reaction tube was brought into a nitrogen filled glovebox and cesium carbonate (359 g, 1.1 mmol, 1.1 equiv.) was added followed by 1,4-dioxane (4 mL) by syringe. The pressure tube was capped, removed from the glove box, and stirred in a preheated oil bath at 120° C. until the reaction mixture was very viscous and near-solid (typically ˜4 hours). The reaction mixture was then removed from heat, diluted with chloroform (10 mL) and stirred for 15 minutes. The mixture was then filtered through a pad of celite, rinsing with additional chloroform, and the solvent fully removed via rotary evaporation. The polymer was redissolved in the minimum amount of chloroform and precipitated into ethyl acetate with vigorous stirring. The solid was then filtered and dried under vacuum to provide the title polymer as a yellow solid. Yield: 186 mg, 66%, SEC (CHCl₃, RI): M_{w}=194 kDa, Ð=24.6, ¹H NMR: Same as given in Example 1.

### Example 4: Exemplary Polymerization with Pd(OAc)₂ Catalyst

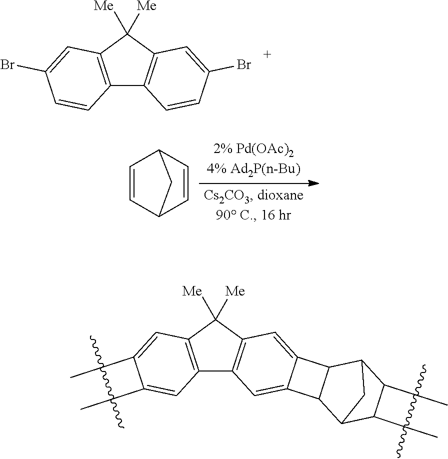

A 15 mL screw-top pressure tube equipped with a magnetic stir bar and Teflon screw cap was charged with 2,7-dibromo-9,9-dimethylfluorene (704 mg, 2 mmol, 1 equiv), palladium acetate (18 mg, 0.08 mmol, 2 mol %) and Ad₂P(n-Bu) (57 mg, 0.16 mmol, 4 mol %). The reaction tube was brought into a nitrogen filled glovebox and cesium carbonate (1.43 g, 4.4 mmol, 1.1 equiv.) was added followed by norbornadiene (203 μL, 2 mmol, 1 equiv.) and 1,4-dioxane (4 mL) by syringe. The pressure tube was capped, removed from the glove box, and stirred in a preheated oil bath at 90° C. until the reaction mixture was very viscous and near-solid (typically ˜16 hours). The reaction mixture was then removed from heat, diluted with chloroform (10 mL) and stirred for 15 minutes. The mixture was then filtered through a pad of celite, rinsing with additional chloroform, and the solvent fully removed via rotary evaporation. The polymer was redissolved in the minimum amount of chloroform and precipitated into ethyl acetate with vigorous stirring. The solid was then filtered and dried under vacuum to provide the title polymer as a yellow solid. Yield: 306 mg, 54%, SEC (CHCl₃, RI): M_{w}=24.6 kDa, Ð=2.7, ¹H NMR: Same as given in Example 1.

### Example 5: Exemplary Polymerization with Pd(Dba)₃ Catalyst

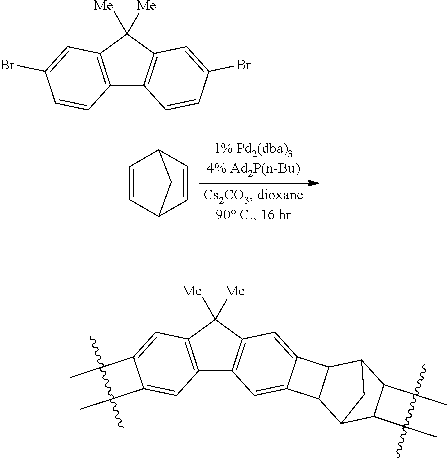

A 15 mL screw-top pressure tube equipped with a magnetic stir bar and Teflon screw cap was charged with 2,7-dibromo-9,9-dimethylfluorene (704 mg, 2 mmol, 1 equiv), Pd₂(dba)₃ (37 mg, 0.04 mmol, 2 mol %) and Ad₂P(n-Bu) (57 mg, 0.16 mmol, 4 mol %). The reaction tube was brought into a nitrogen filled glovebox and cesium carbonate (1.43 g, 4.4 mmol, 1.1 equiv.) was added followed by norbornadiene (203 μL, 2 mmol, 1 equiv.) and 1,4-dioxane (4 mL) by syringe. The pressure tube was capped, removed from the glove box, and stirred in a preheated oil bath at 90° C. until the reaction mixture was very viscous and near-solid (typically ˜16 hours). The reaction mixture was then removed from heat, diluted with chloroform (10 mL) and stirred for 15 minutes. The mixture was then filtered through a pad of celite, rinsing with additional chloroform, and the solvent fully removed via rotary evaporation. The polymer was redissolved in the minimum amount of chloroform and precipitated into ethyl acetate with vigorous stirring. The solid was then filtered and dried under vacuum to provide the title polymer as a yellow solid. Yield: 413 mg, 73%, SEC (CHCl₃, RI): M_{w}=15.6 kDa, Ð=2.1, ¹H NMR: Same as given in Example 1.

### Example 6: Exemplary Polymerization of Aryl Triflate

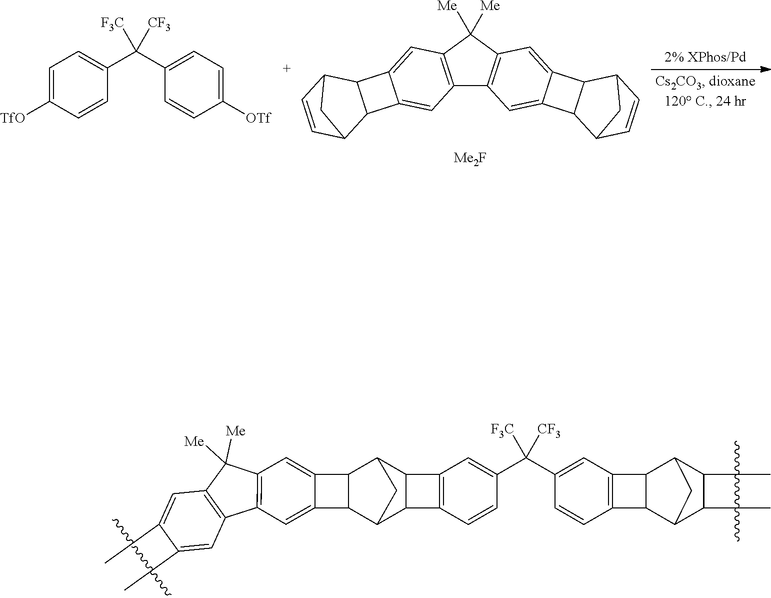

A 15 mL screw-top pressure tube equipped with a magnetic stir bar and Teflon screw cap was charged with bisphenol AF ditriflate (234 mg, 0.5 mmol, 1 equiv.), Me₂F monomer (187 mg, 0.5 mmol, 1 equiv.), G4 palladium dimer (15 mg, 0.04 mmol, 4 mol %) and XPhos (18 mg, 0.04 mmol, 4 mol %). The reaction tube was brought into a nitrogen filled glovebox and cesium carbonate (359 mg, 1.1 mmol, 1.1 equiv.) was added followed by 1,4-dioxane (4 mL) by syringe. The pressure tube was capped, removed from the glove box, and stirred in a preheated oil bath at 120° C. until the reaction mixture was very viscous and near-solid (typically ˜4 hours). The reaction mixture was then removed from heat, diluted with chloroform (10 mL) and stirred for 15 minutes. The mixture was then filtered through a pad of celite, rinsing with additional chloroform, and the solvent fully removed via rotary evaporation. The polymer was redissolved in the minimum amount of chloroform and precipitated into methanol with vigorous stirring. The solid was then filtered and dried under vacuum to provide the title polymer as a white solid. Yield: 205 mg, 65%, SEC (CHC₃, RI): M_{w}=19.5 kDa, Ð=1.7, ¹H NMR: (399 MHz, Chloroform-d) δ 7.41 (d, J=7.9 Hz, 4H), 7.22-6.94 (m, 6H), 3.31 (d, J=16.4 Hz, 3H), 3.15 (s, 3H), 2.82 (d, J=6.2 Hz, 3H), 2.41 (s, 2H), 1.47-1.39 (m, 6H), 0.95 (t, J=8.0 Hz, 2H) ppm.

### Example 7: Exemplary Preparation of an Exemplary Alternating Copolymer

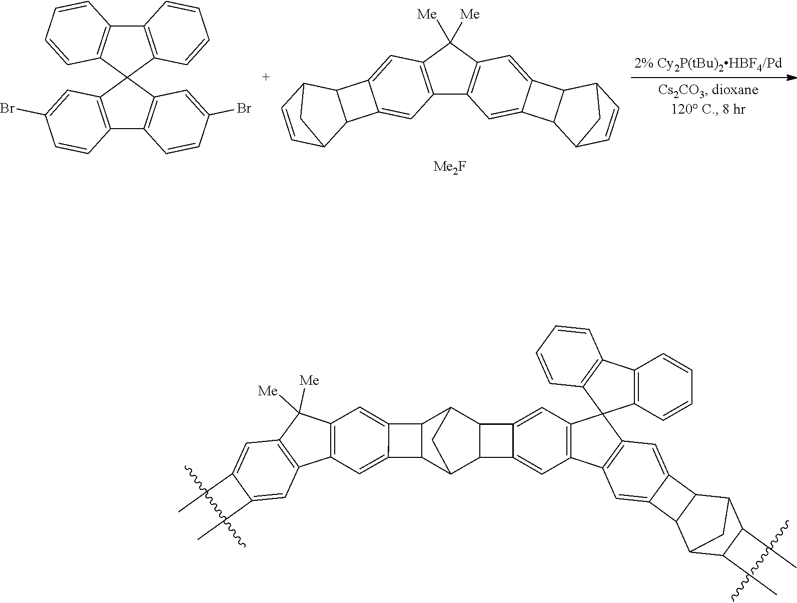

A 15 mL screw-top pressure tube equipped with a magnetic stir bar and Teflon screw cap was charged with 2, 7-dibromospirobifluorene (237 mg, 0.5 mmol, 1 equiv.), Me₂F monomer (187 mg, 0.5 mmol, 1 equiv.), G4 palladium dimer (7.6 mg, 0.02 mmol, 2 mol %) and tBuPCy₂·HBF₄ (7 mg, 0.02 mmol, 2 mol %). The reaction tube was brought into a nitrogen filled glovebox and cesium carbonate (359 mg, 1.1 mmol, 1.1 equiv.) was added followed by 1,4-dioxane (4 mL) by syringe. The pressure tube was capped, removed from the glove box, and stirred in a preheated oil bath at 90° C. until the reaction mixture was very viscous and near-solid (typically ˜8 hours). The reaction mixture was then removed from heat, diluted with chloroform (10 mL) and stirred for 15 minutes. The mixture was then filtered through a pad of celite, rinsing with additional chloroform, and the solvent fully removed via rotary evaporation. The polymer was redissolved in the minimum amount of chloroform and precipitated into ethyl acetate with vigorous stirring. The solid was then filtered and dried under vacuum to provide the title polymer as a yellow solid. Yield: 205 mg, 65%, SEC (CHC₃, RI): M_{w}=19.5 kDa, Ð=1.7, ¹H NMR: ¹H NMR (500 MHz, Chloroform-d) δ 7.84 (s, 2H), 7.47 (s, 2H), 7.35 (s, 4H), 7.04 (d, J=42.3 Hz, 6H), 6.72 (s, 2H), 6.41-6.29 (m, 2H), 3.50 (s, 3H), 3.33-3.09 (m, 9H), 2.45 (s, 2H), 1.40 (d, J=21.6 Hz, 10H), 0.78 (s, 2H) ppm.

### Example 8: Comparison of Polymer Characteristics Made by Varying Methods

| Entry | Source of Method | Yield (%) | Conversion (%) |
|---|---|---|---|
| 1 | present disclosure¹ | 77% | >99% |
| 2 | US9708443B2² | N/A⁵ | >90% |
| 3 | US9708443B2³ | N/A⁵ | >90% |
| 4 | WO2021101659A3⁴ | N/A⁵ | >90% |

¹Reaction conditions: 1 mol % Pd(OAc)₂, 2 mol % tBuPCy₂, 110 mol % Cs₂CO₃, 0.5M in 1,4-dioxane, 90° C., 16 hours.
²Reaction conditions: 1 mol % Pd(OAc)₂, 2 mol % PPh₃, 100 mol % Cs₂CO₃, 0.1 molar in toluene, 130° C., 5 hours.
³Reaction conditions: 0.1 mol % Pd(OAc)₂, 0.2 mol % PPh₃, 100 mol % Cs₂CO₃, 0.1 molar in tetrahydrofuran, 115° C., 24 hours.
⁴Reaction conditions: 1 mol % Pd(OAc)₂, 2 mol % PPh₃, 100 mol % Cs₂CO₃, 1 molar in tetrahydrofuran, 150° C., 24 hours.
⁵Reactions provided exclusively low M_{w} (<5,000) and insoluble cross-linked/branched material.

### Example 9: Exemplary Prophetic Preparation of Several Alternating Copolymers

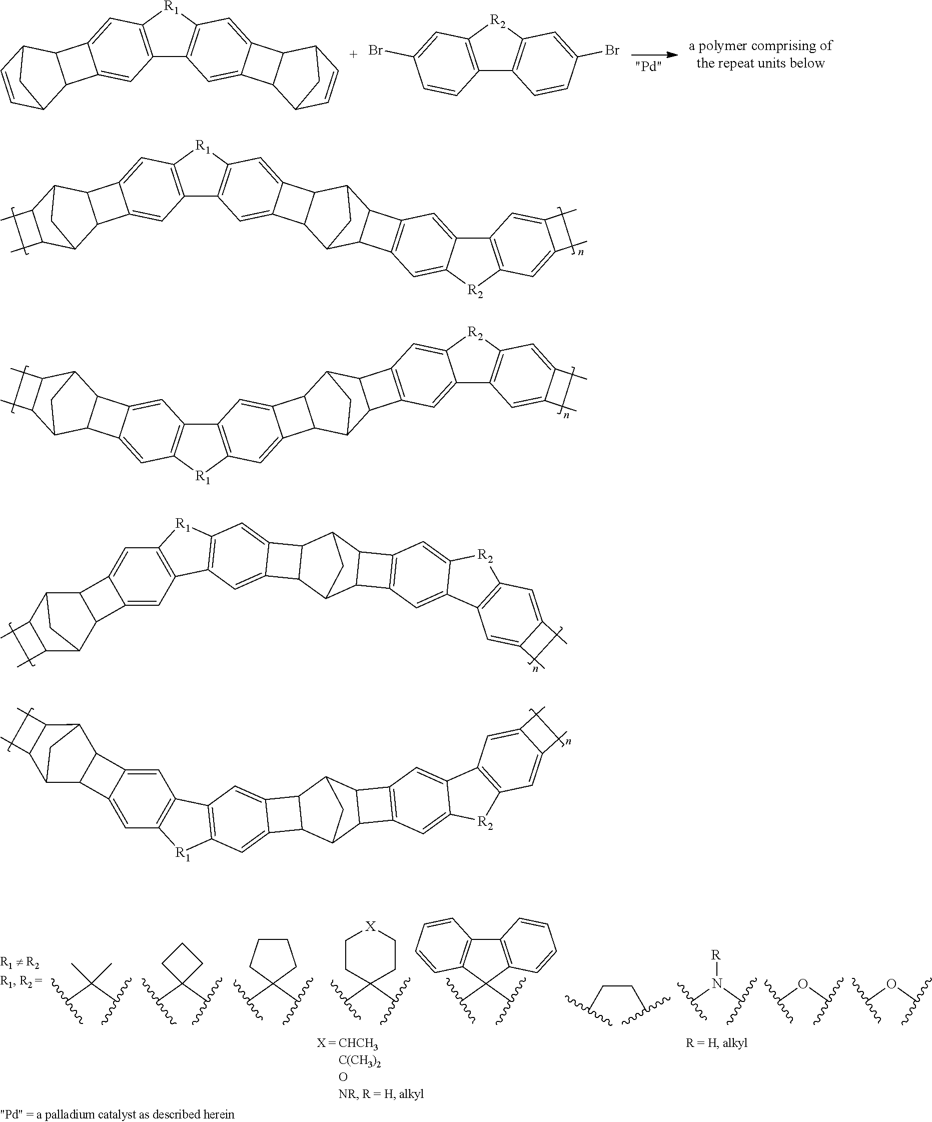

### Example 10: Exemplary Prophetic Preparation of Statistical Copolymers

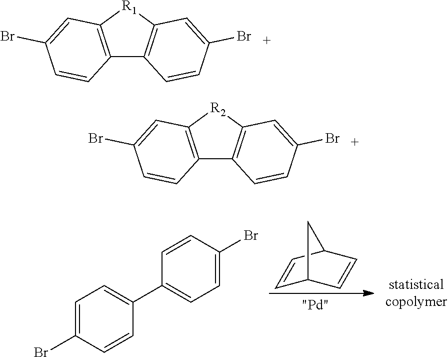

This example demonstrates the polymerization of two or more aryl dibromides with 2,5-norbornadiene to make statistical copolymers in a single step.

### Example 11: Exemplary Prophetic Polymer Membrane Preparation

For a typical polymer membrane, 100 mg of polymer will be dissolved in 6 g of chloroform (˜2 wt. % solution), and the solution transferred into a flat, 5-cm Petri dish with a Norton® fluorinated ethylene propylene liner (WELCH Fluorocarbon, Inc.). The Petri dish will be covered with a watch glass slow down the evaporation. The solvent evaporation will occur in about 1-2 days to form a flat film.

### Example 12: Exemplary Prophetic Gas Separation Protocol

The polymer membranes of the present disclosure can be used in various art-recognized fluid separation methods. Non-limiting examples of such methods may be found in International Application WO 2021/101659, which is expressly incorporated by reference herein.

Experiments will be performed on a constant-volume variable-pressure apparatus at 35° C. and 1 bar upstream pressure, unless otherwise stated. Before permeation experiments, polymer films will be heated at 120° C. under vacuum for 24 h or heated at 120° C. under vacuum for 24 h and then soaked in liquid methanol for 24 h. The films will then be masked with epoxy on brass support and further degassed at 35° C. under high vacuum(<0.02 Torr) for 8 h in the permeation apparatus. Variable-temperature pure-gas permeation experiments will be performed at 25° C., 35° C., 45° C., and 55° C.

### INCORPORATION BY REFERENCE

All publications and patents mentioned herein are hereby incorporated by reference in their entirety as if each individual publication or patent was specifically and individually indicated to be incorporated by reference. In case of conflict, the present application, including any definitions herein, will control.

### EQUIVALENTS

While specific embodiments of the subject invention have been discussed, the above specification is illustrative and not restrictive. Many variations of the invention will become apparent to those skilled in the art upon review of this specification and the claims below. The full scope of the invention should be determined by reference to the claims, along with their full scope of equivalents, and the specification, along with such variations.

We claim:

1. A polymer comprising at least one unit of Formula I, wherein Formula I consists of a subunit of Formula I′ and a subunit of Formula I″: 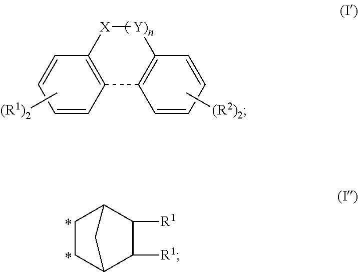
wherein:
each R¹ represents a connection point to the polymer;
each of the two R¹ groups on the subunit of Formula I′ is on an adjacent carbon to another R¹ group;
each R² represents a connection point between the subunit of Formula I′ and a carbon marked with an * on the subunit of Formula I″;
each of the two R² groups is on an adjacent carbon to another R² group;
X is, independently at each occurrence, selected from NR^{A}, O, S, CR^{B}R^{C}, S═O, and C═O;
when present, Y is, independently at each occurrence, selected from NR^{A}, O, S, CR^{B}R^{C}, and C═O;
wherein, when Y is present, at least one of X and Y is CR^{B}R^{C} or C═O;
R^{A} is, independently at each occurrence, selected from H, alkyl, —O-alkyl, or haloalkyl;
R^{B} and R^{C} are, independently at each occurrence, selected from H, OH, SH, halo, amine, alkyl, —(H)C═O, —O-alkyl, and haloalkyl;
or R^{B} and R^{C}, together with the atom to which they are attached, form a cycloalkyl, cycloalkenyl, heterocycloalkenyl, or heterocycloalkyl, which is optionally substituted with one or more R^{G}, wherein R^{G} is selected from H, alkyl, alkyoxyl, and hydroxyl;
n is O or 1; and
--- represents an optional bond.

2. The polymer of claim 1, wherein the polymer comprises a plurality of repeat units of Formula I.

3. The polymer of claim 1 or 2, comprising a unit of Formula Ia:

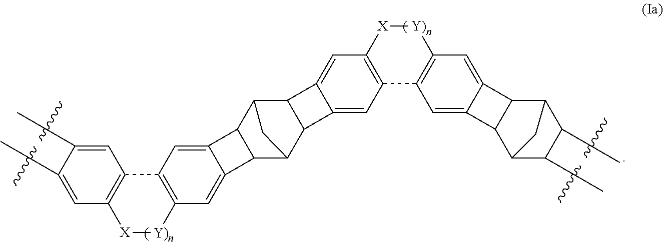

4. The polymer of claim 1, further comprising another co-monomer.

5. The polymer of any one of claims 1-4, wherein the at least one unit of Formula I is a unit of Formula II:

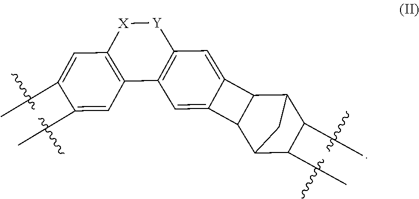

6. The polymer of claim 5, wherein the at least one unit of Formula II is a unit of Formula IIa:

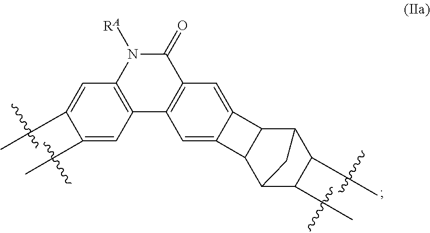

7. The method of claim 6, wherein R^{A} is H or alkyl.

8. The polymer of claim 5, wherein the at least one unit of Formula II is a unit of Formula IIb:

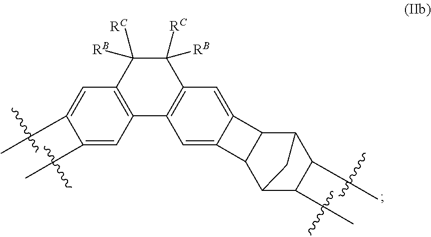

9. The polymer of claim 5, wherein the at least one unit of Formula II is selected from:

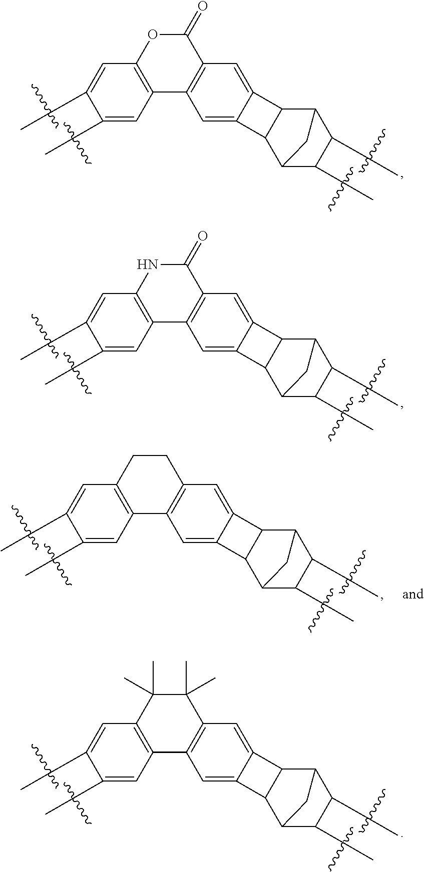

10. The polymer of any one of claims 1-4, wherein the at least one unit of Formula I is a unit of Formula III:

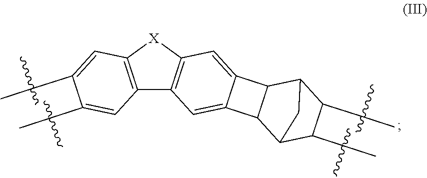

11. The polymer of claim 10, wherein the at least one unit of Formula III is a unit of Formula IIIb:

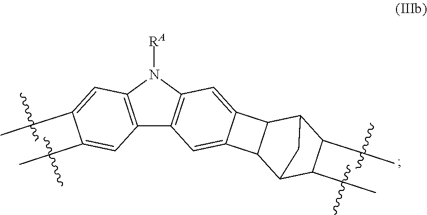

12. The polymer of claim 11, wherein R^{A} is H or alkyl.

13. The polymer of claim 10, wherein the at least one unit of Formula III is a unit of Formula IIIc:

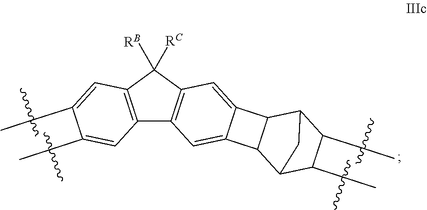

14. The polymer of claim 13, wherein R^{B} and R^{C}, together with the atom to which they are attached, form a heterocycloalkyl.

15. The polymer of claim 13, wherein R^{B} and R^{C} are, independently at each occurrence, alkyl or fluoroalkyl.

16. The polymer of claim 13, wherein R^{B} and R^{C} are each H.

17. The polymer of claim 13, wherein the at least one unit of Formula III is selected from:

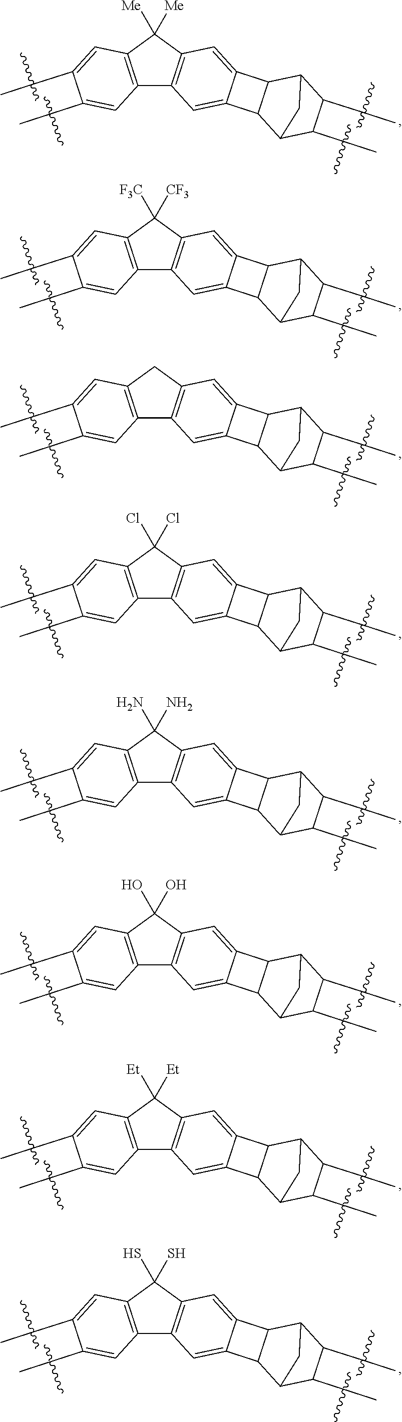

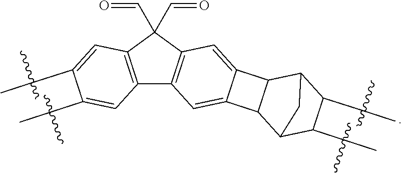

18. The polymer of claim 10, wherein the at least one unit of Formula III is a unit of Formula IIId, 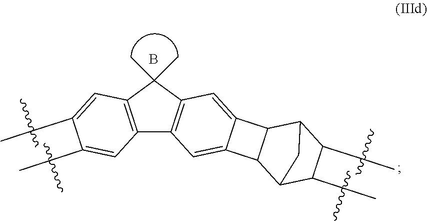
wherein Ring B is a cycloalkyl, cycloalkenyl, heterocycloalkenyl, or heterocycloalkyl, which is optionally substituted with one or more R^{G}, wherein R^{G} is selected from H, alkyl, alkyoxyl, and hydroxyl.

19. The polymer of claim 18, wherein Ring B is a five- or six-membered ring.

20. The polymer of claim 18 or 19, wherein Ring B is selected from cyclopentane, cyclohexane, tetrahydropyran, dioxolane, dioxane, dithiolane, pyrimidine, and 3,4-dihydro-2H-pyrrole; and Ring B is optionally substituted with one or more R^{G}.

21. The polymer of claim 10, wherein the at least one unit of Formula III is selected from:

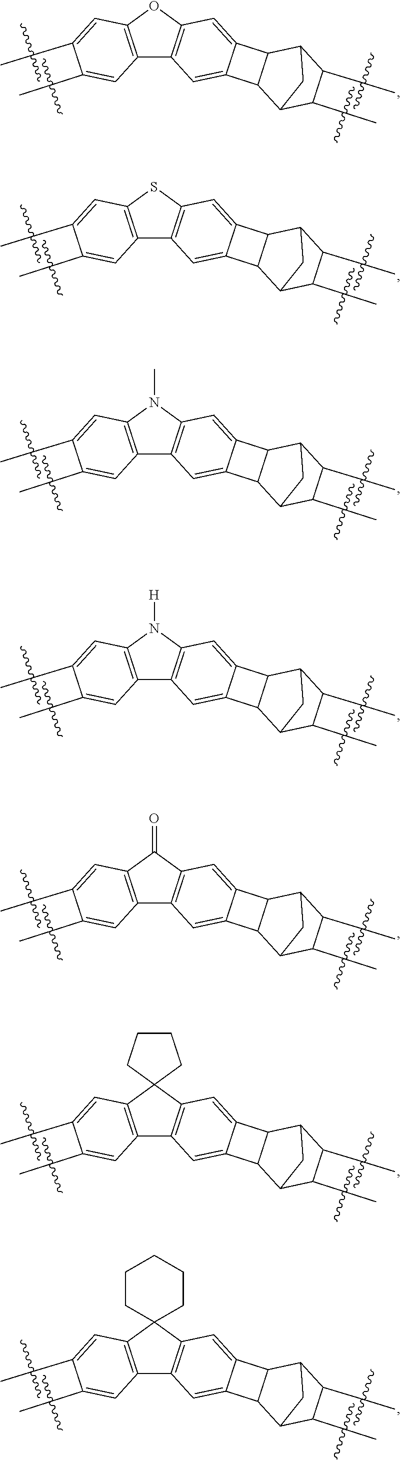

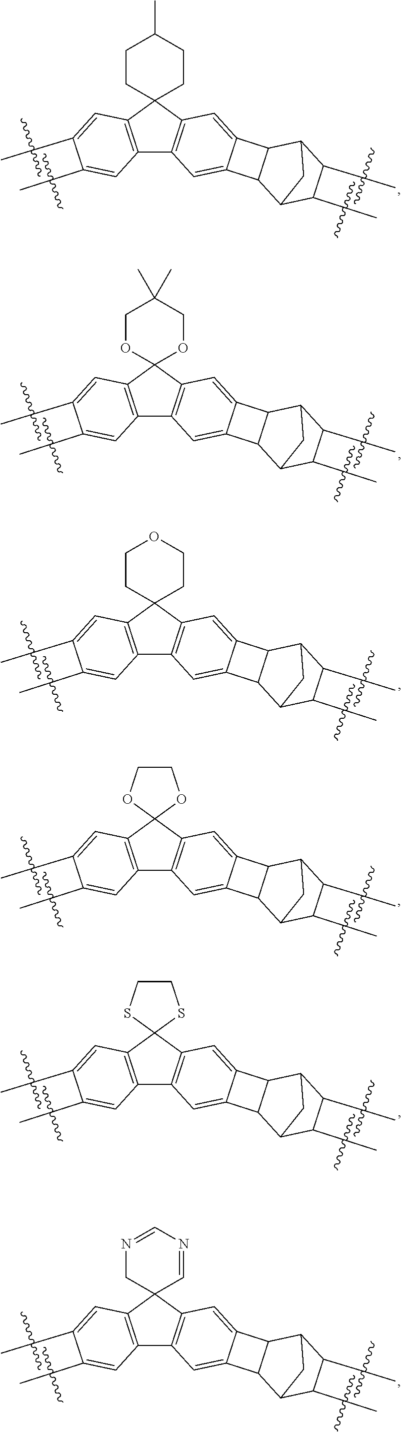

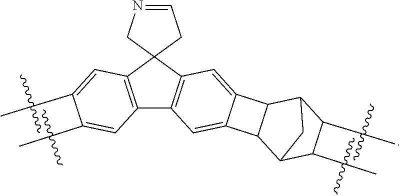

22. The polymer of any one of claims 1-4, wherein the at least one unit of Formula I is a unit of Formula IV:

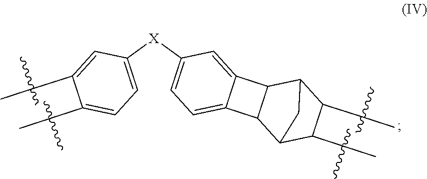

23. The polymer of claim 22, wherein the at least one unit of Formula IV is a unit of Formula IVa:

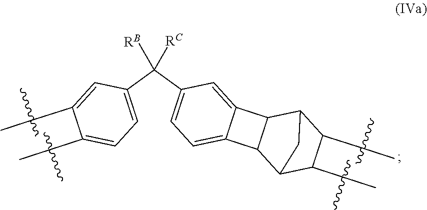

24. The method of claim 22, wherein the at least one unit of Formula IV is selected from:

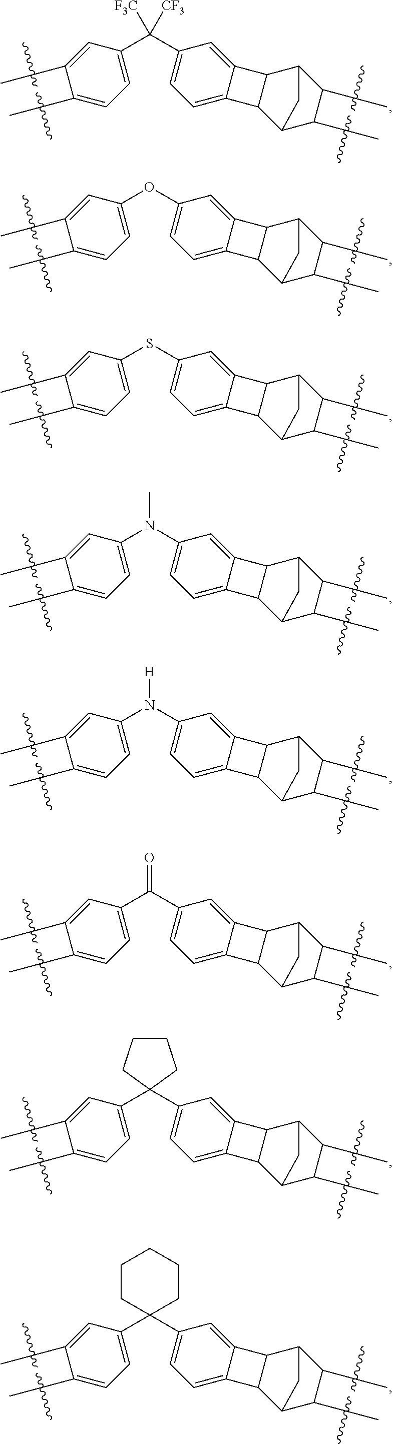

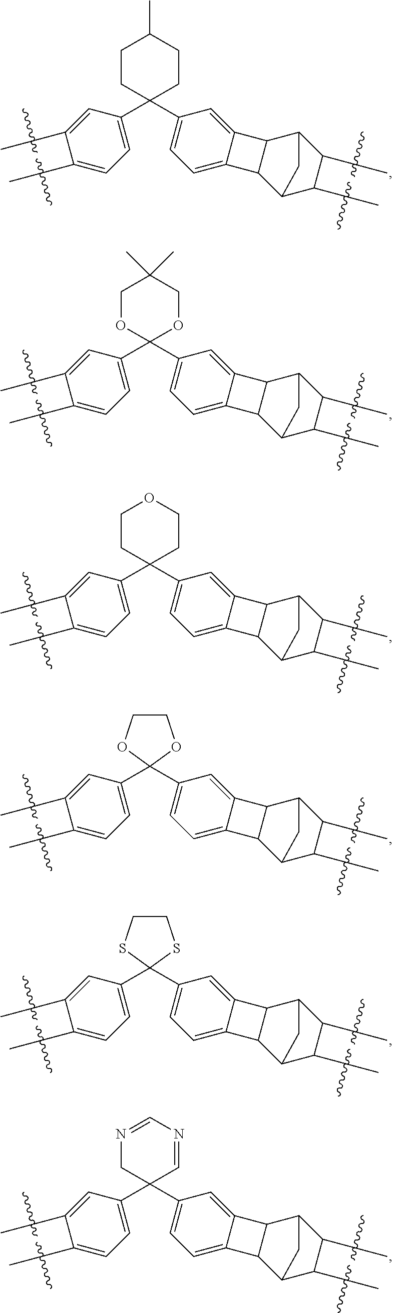

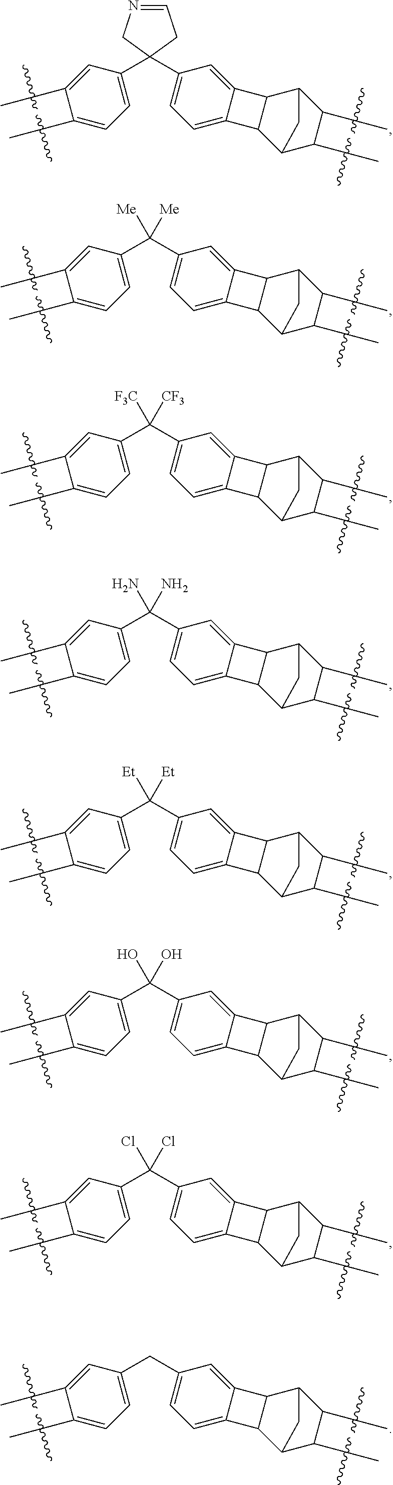

25. The polymer of any one of claims 1-4, wherein the at least one unit of Formula I is a unit of Formula V:

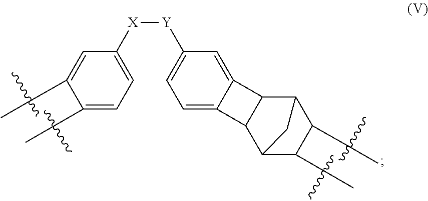

26. The polymer of claim 25, wherein the at least one unit of Formula V is selected from:

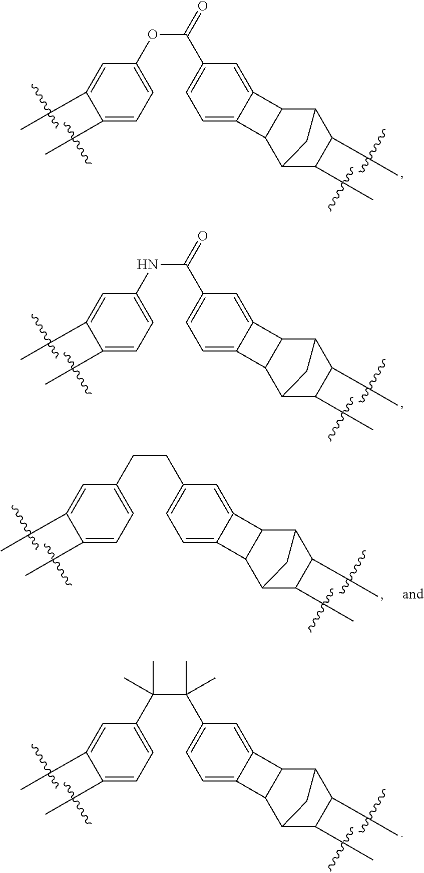

27. The polymer of any one of claims 1-26, wherein the polymer comprises over 20 units.

28. The polymer of any one of claims 1-26, wherein the polymer comprises over 20 units of Formula I.

29. The polymer of any one of claims 1-28, wherein the polymer has a weight average molecular weight (M_{W}) of greater than 100,000 g.

30. The polymer of any one of claims 1-29, wherein the polymer has a glass transition temperature (T_{G}) that is greater than its decomposition temperature.

31. A method of separating mixtures of fluids comprising passing a mixture of fluids through a separation membrane comprising the polymer of any one of claims 1-30.

32. A method of making the polymer of any one of claims 1-31.

33. The method of claim 32, wherein the method comprises:
reacting a compound of Formula Ia: 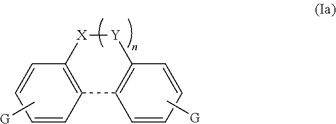
wherein each G is independently a halide or pseudohalide, such as a triflate, nonaflate, tosylate, or methanesulfonate;
with norbornadiene in the presence of a palladium catalyst, a ligand, and a base.

34. The method of claim 33, wherein the palladium catalyst is a palladium(II) salt, an organometallic palladium(II) complex, or a palladium(0) compound.

35. The method of claim 34, wherein the palladium catalyst is selected from G4 palladium dimer, Pd(OAc)₂, and Pd₂(dba)₃.

36. The method of any one of claims 33-35, wherein the ligand is a phosphine, a phosphite, or a carbene.

37. The method of any one of claims 33-36, wherein the ligand is selected from ^{t}BuPCy₂, Cy₂P(^{t}Bu)₂·HBF₄, Ad₂P(n-Bu), XPhos, DavePhos, SPhos, RuPhos, BrettPhos, tBuXPhos, XantPhos, dialkylarylbiarylphosphines, and tris-arylphosphines, such as PPh₃.

38. The method of claim 36, wherein the ligand is an N-Heterocyclic Carbene.

39. The method of claim 38, wherein the ligand is an imidazolylidene, such as IPr, IMes, sIPr, SIPr, SIMes.

40. The method of any one of claims 33-39, wherein the base is a carbonate base, a tribasic phosphate base, a phenoxide base, or a tert-butoxide base.

41. The method of any one of claims 33-40, wherein the base is Cs₂CO₃.

42. A method of making a polymer, the polymer comprising at least one unit of Formula X: 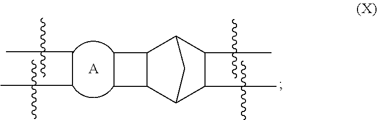
wherein A is a moiety comprising at least two aromatic rings;
wherein the method comprises reacting a compound of formula Xa: 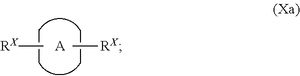
wherein R^{X} is a halide or pseudohalide, such as a triflate, nonaflate, tosylate, or methanesulfonate;
with norbornadiene, in the presence of a palladium catalyst, a ligand, and a base.

43. The method of claim 42, wherein the compound of formula Xa is selected from: 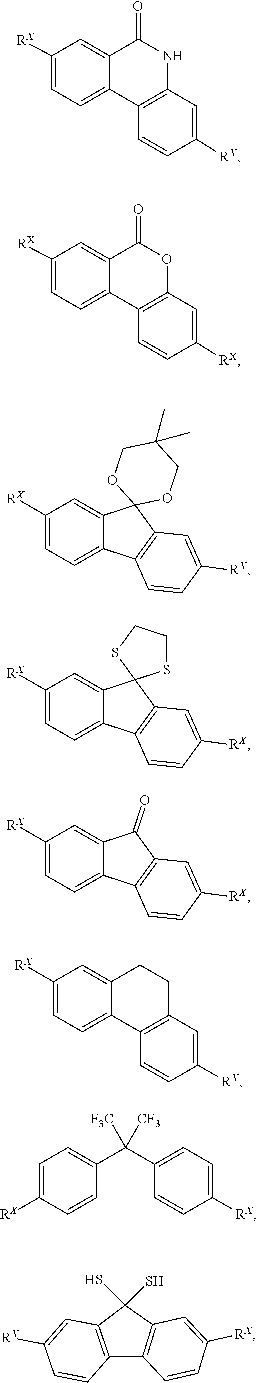 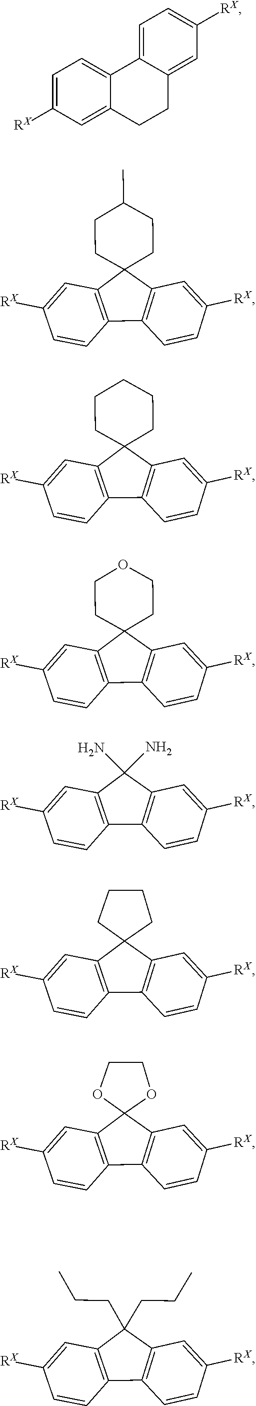 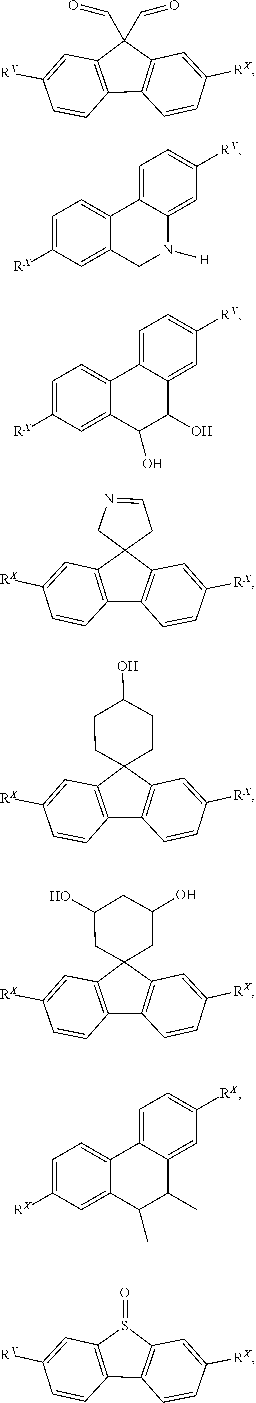 [chemical structure]
